(19) United States
(12) Patent Application Publication
(10) Pub. No.: US 2008/0243573 A1
(43) Pub. Date: Oct. 2, 2008

(54) METHODS AND APPARATUS FOR IMPROVING THE ACCURACY AND REACH OF ELECTRONIC MEDIA EXPOSURE MEASUREMENT SYSTEMS

(76) Inventors: Kamal Nasser, Palm Harbor, FL (US); Peter Campbell Doe, Ridgewood, NJ (US); Wendy Malley, Hoffman Estates, IL (US); Lorraine Hadfield, Pennington, NJ (US); James W. Baker, Seattle, WA (US); Daniel L. Pasco, Seattle, WA (US); Roger D. Percy, Seattle, WA (US); R. Cameron Percy, Seattle, WA (US); Kay S. Burke, Seattle, WA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/117,181

(22) Filed: May 8, 2008

Related U.S. Application Data
(63) Continuation of application No. 11/668,931, filed on Jan. 30, 2007.
Application No. 11/668,931 is a continuation of application No. PCT/US05/27327, filed on Jul. 29, 2005.
(60) Provisional application No. 60/592,554, filed on Jul. 30, 2004.
(60) Provisional application No. 60/681,785, filed on May 17, 2005.
(60) Provisional application No. 60/688,494, filed on Jun. 8, 2005.

(51) Int. Cl. G06Q 10/00

(52) U.S. Cl. 705/7

(57) ABSTRACT

Methods and apparatus for crediting media exposure are disclosed. An example method includes deriving a plurality of travel paths traversed by respective ones of a plurality of respondents, determining, via a first technique, exposures of the respective ones of the plurality of respondents to a plurality of media sites based on the derived plurality of travel paths, and modifying the determined exposures to the plurality of media sites to improve a statistical accuracy of the modified determined exposures by constraining the determined exposures based on exposure information for the plurality of media sites obtained via a second technique different than the first technique.

### RELATED APPLICATIONS

This patent is a continuation of U.S. application Ser. No. 11/668,931 filed on Jan. 30, 2007, entitled “Methods and Apparatus for Improving the Accuracy and Reach of Electronic Media Exposure Measurement Systems,” which is a continuation of International Application Serial Number PCT/US2005/027327, entitled “Methods and Apparatus for Improving the Accuracy and Reach of Electronic Media Exposure Measurement Systems” filed on Jul. 29, 2005. This patent claims benefit of U.S. Provisional Application Ser. No. 60/592,554, entitled “Methods and Apparatus for Processing Data Collected by a GPS-enabled Media Measurement System” and filed on Jul. 30, 2004; U.S. Provisional Application Ser. No. 60/681,785, entitled “Methods and Apparatus for Improving the Accuracy and Reach of Electronic Media Exposure Measurement Systems” and filed on May 17, 2005; and U.S. Provisional Application Ser. No. 60/688,494 entitled “Methods and Apparatus for Improving the Accuracy and Reach of Electronic Media Exposure Measurement Systems” and filed on Jun. 8, 2005. U.S. application Ser. No. 11/668,931; International Application Serial Number PCT/US2005/027327; U.S. Provisional Application Ser. Nos. 60/592,554, 60/681,785 and 60/688,494; and U.S. application Ser. Nos. 10/686,872 and 10/318,422 are hereby incorporated by reference in their entireties.

### FIELD OF THE DISCLOSURE

This disclosure relates generally to media exposure measurement systems and, more particularly, to methods and apparatus for improving the accuracy and reach of electronic media exposure measurement systems.

### BACKGROUND

In the past, media exposure measurement systems for outdoor media relied, for example, on automotive traffic studies (e.g., counting the number of cars traveling down a road on a given day), or claimed recall (e.g., an ability of consumers, through surveys, to remember seeing outdoor advertising) to determine the number of media exposures that were achieved.

More recently, electronic systems for measuring and crediting media exposure have been developed, enabling outdoor advertisers to measure and establish with scientific and verifiable accuracy the reach of their outdoor media sites. FIG. 1 illustrates an example prior art electronic media exposure measurement system 100 that uses satellite positioning system (SPS) (e.g., the U.S. Global Positioning System (GPS) and the European Galileo System (currently under construction)) technology to track motorist and/or pedestrian exposure to outdoor media sites. To track exposure of a participant or a respondent 102, the respondent 102 carries (or wears) an SPS enabled monitoring device 110 (e.g., the Nielsen® personal outdoor device (Npod™)). The device 110 periodically (e.g., every 4 to 5 seconds) acquires and receives a plurality of signals transmitted by a plurality of SPS satellites 105A-C and uses the plurality of received signals to calculate a current geographic location (i.e., a position fix) for the device 110 and a current time of day. Typically, the device 110 requires the reception of signals from a minimum number of SPS satellites 105A-C (e.g., in the GPS system, the device 110 requires transmitted signals from at least three or four GPS satellites) to determine the current geographic location of the device 110, and, thus, the respondent 102. The device 110 sequentially stores the result of each position fix (e.g., geo-code location data and the time of day and, if desired, the date) for later processing by a computing device 125.

The sequence of recorded position fix data (e.g., sets of corresponding geo-code location data and time of day and/or date values) are downloaded from the device 110 to a download server 120 on an occasional, periodic, or real time basis. The download server 120 may be either a respondent's personal computer (PC) or a computer associated with the electronic measuring system 100. The download server 120, in turn, provides the downloaded travel path data (i.e., the sequence of recorded position fix data) to the computing device 125. Any of a variety of well-known techniques for downloading data from the device 110 to the download server 120, and transferring the data from the download server 120 to the computing device 125 can be used. For example, the device 110 can be attached to the download server 120 using a universal serial bus (USB) connection and utilize removable storage device drivers executing on the device 110 and the download server 120.

To determine exposure to a media site 115, the computing device 125 compares the location of each of the position fixes recorded by the device 110 to the location of the media site 115. The location of the media site 115 is available in a database 130 that contains, among other data or information, geo-code location data for a plurality of media sites. In the example system 100 of FIG. 1, if the respondent's location is ‘close enough’ to (e.g., within a predetermined distance of) the media site 115, then the media site 115 is credited with a media exposure.

The geo-code location data for media sites are generated and provided by industry marketing organizations (e.g., Traffic Audit Bureau (TAB)) and are used by the computing device 125 during the matching of recorded position fixes with known media site locations. However, the geo-code location data provided in the database 130 may be incomplete and/or sometimes inaccurate. For example, the database 130 may contain a textual description (e.g., on Madison Blvd. between 1^{st} Street and 2^{nd} Street) of the location of the media site 115 but not contain actual geo-code location data.

For a variety of reasons the device 110 may be unable to complete a position fix attempt. For example, the device 110 may not be able to acquire and receive signals from the requisite number of satellites 105A-C (due to, for example, signal attenuation caused by thick foliage, or a structure, either man-made or naturally occurring, that obstructs the path of communication between the SPS satellites 105A-C and the device 110. The confines of a building, a parking structure, a tunnel, a subway system, etc. are examples of areas in which obstructed communications paths may commonly occur. Further, a successful position fix may lack accuracy due to multipath distortions caused by nearby objects (e.g., tall buildings in downtown areas) or due to clock (i.e., timing) mismatches or errors. In such circumstances, the sequence of position fixes recorded by the device 110 and subsequently processed by the computing device 125 may contain gaps in the travel path traversed by the respondent 102 or represent a traversed path that does not follow a known course of travel (e.g., street, road, lane, highway, interstate, bridge, sidewalk, pedestrian walkway, trail, tunnel, etc.).

### BRIEF DESCRIPTION OF THE DRAWINGS

FIG. 1 is an example of a known electronic media exposure measurement system.

FIG. 2 is a schematic illustration of an example manner of implementing an SPS enabled device.

FIG. 3 is a schematic illustration of an example media exposure computing device constructed in accordance with the teachings of the invention.

FIG. 4A illustrates an example manner of implementing the travel path processor of FIG. 3.

FIG. 4B illustrates an example filter configuration used to implement the example processing engine of FIG. 4A.

FIG. 5 is a schematic illustration of an example manner of implementing the example media site processor of FIG. 3.

FIG. 6A is a flowchart representative of example machine readable instructions which may be executed to implement the example pre-processor of FIG. 3.

FIG. 6B is a flowchart representative of example machine readable instructions which may be executed to implement the example media site processor of FIG. 3.

FIG. 6C is a flowchart representative of example machine readable instructions which may be executed to implement the example travel path processor of FIG. 3.

FIG. 7A illustrates a portion of an example travel path.

FIG. 7B illustrates an example deterministic path constructed from the example travel path of FIG. 7A.

FIG. 7C illustrates an example decision tree constructed from the example travel path of FIG. 7A.

FIG. 8A illustrates example recorded travel path data.

FIGS. 8B and 8C illustrate computation of two data moments using the example travel path data of FIG. 8A.

FIG. 9A illustrates example contextual analysis bonuses that may be used in the example street constraint filter of FIG. 4B.

FIGS. 9B-G illustrate example contextual analysis penalties that may be used in the example street constraint filter of FIG. 4B.

FIG. 10 is a diagram illustrating an example impact zone associated with a media site.

FIG. 11 is a diagram illustrating a straight travel path traversing the example impact zone of FIG. 10.

FIG. 12 is a diagram illustrating a curved travel path traversing the example impact zone of FIG. 10.

FIG. 13 is a diagram illustrating impact zones associated with a mobile bus.

FIG. 14 illustrates an example manner in which the impact zones associated with a bus may be handled.

FIGS. 15-17 are flowcharts representative of example machine readable instructions which may be executed to implement the example passage processor of FIG. 3.

FIG. 18 is a schematic illustration of an example manner of implementing the example statistics processing device of FIG. 3.

FIG. 19 illustrates example passage data before and after an example data harmonization.

FIG. 20 is a flowchart representative of example machine readable instructions which may be executed to implement the example statistics processing device of FIG. 3.

FIG. 21 is a flowchart representative of example machine readable instructions which may be executed to implement the example data fusion processor of FIG. 18.

FIG. 22 is a flowchart representative of example machine readable instructions which may be executed to implement the example frequency and reach processor of FIG. 18.

FIG. 23 is a schematic illustration of an example processor platform that may execute the example machine readable instructions represented by FIGS. 6A-C, 15-17, and 20-22.

### DETAILED DESCRIPTION

Although the example apparatus described herein includes, among other components, software executed on hardware, such apparatus is merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

In addition, while the following disclosure is made with respect to example SPS-based electronic media measurement systems, it should be understood that the disclosed apparatus is readily applicable to many other electronic media measurement systems. Accordingly, while the following describes example apparatus, methods, and articles of manufacture, persons of ordinary skill in the art will readily appreciate that the disclosed examples are not the only way to implement such systems.

In general, the example apparatus, methods, and articles of manufacture described herein may be used to process data specifying a plurality of locations traversed by a respondent. In the particular examples described herein, the data is processed so that the processed data better represents a path of travel along known courses of travel (e.g., streets, roads, lanes, highways, interstates, bridges, sidewalks, pedestrian walkways, trails, tunnels, etc.). In additional examples described herein, the data is processed so that it represents travel paths through areas associated with obstructed signal reception and to alleviate deficiencies present in the data. Such deficiencies may include large gaps between locations traversed by the respondent, inaccurate location data, etc.

Further, the example apparatus, methods, and articles of manufacture described herein may be used to associate locations traversed by a respondent with media sites, thereby crediting the media sites with media exposure. In particular examples described herein, media exposure is credited to a media site if the respondent traverses within a geometric impact zone associated with a media site along a direction favoring observation or consumption of the media site. Additional examples described herein apply constraints to be satisfied prior to crediting of media exposure. Further examples described herein associate locations traversed by the respondent with media sites located in areas with obstructed signal reception and with mobile media sites.

The example apparatus, methods, and articles of manufacture described herein may be used to harmonize media exposure credit data to remove statistical anomalies that are not indicative of real-life media exposure characteristics. In particular examples, media exposure credit data is processed so that the credits are within a pre-determined amount of an expected value while maintaining an average site passage estimate. As a result, the examples described herein can be used to improve the accuracy and reach of electronic media measurement systems.

Inaccurate or missing data (e.g., in the sequence of recorded position fixes, or the media site location information) can adversely impact the accuracy of media exposure credits determined by a media exposure computing device. To substantially improve the accuracy and reliability of electronic media exposure measurements, the recorded travel path data and media site location data may be processed using the example methods and apparatus described herein to overcome the deficiencies discussed above.

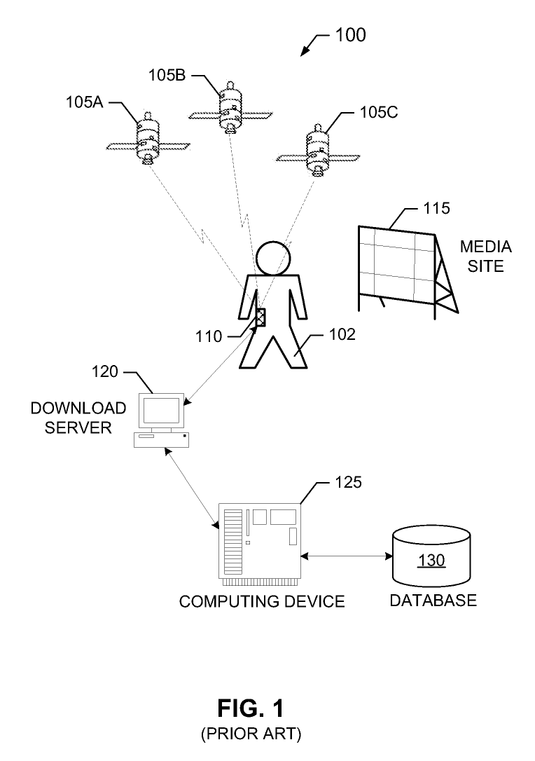

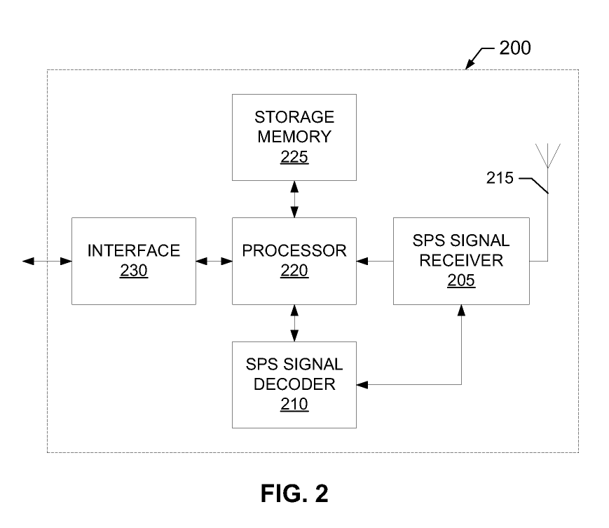

FIG. 2 illustrates an example SPS enabled device 200 that may be use to implement the monitoring device 110 of FIG. 1. To receive and decode signals (i.e., SPS signals) transmitted by the plurality of SPS satellites 105A-C, the device 200 includes an SPS signal receiver 205, an SPS signal decoder 210, and an antenna 215. Using any of a variety of techniques, the SPS signal receiver 205 converts radio frequency (RF) analog signals received by the antenna 215 into digital baseband signals (i.e., received signals) suitable for processing and/or decoding by the SPS signal decoder 210. For example, the SPS signal receiver 205 may be implemented using demodulators, down-converters, filters, and/or analog-to-digital (A/D) converters. Using any of a variety of well-known techniques, the SPS signal decoder 210 processes the received signals to determine, if possible (i.e., if a minimum number of SPS satellites 105A-C are available (e.g., in the GPS system, the SPS signal decoder 210 uses received signals from at least 3 or 4 satellites)), the current location of the device 200 (i.e., to perform a position fix). The SPS signal decoder 210 provides to a processor 220 the current geographic location of the device 200, if determined, as well as the received signals. The processor 220 records into a storage memory 225 both the position fix and the received signals (i.e., pseudorange data). By periodically performing the above methods, the recorded data represents a travel path traversed by the respondent 102 (FIG. 1).

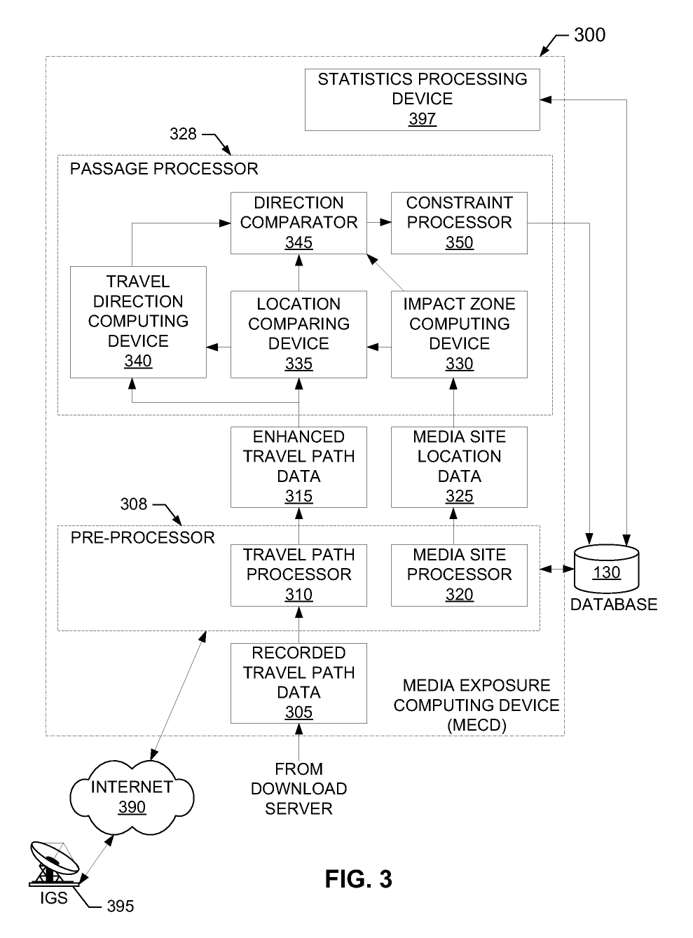

The example device 200 of FIG. 2 further includes an interface 230 to allow the device 200 to communicate with the download server 120 of FIG. 1. The device 200 provides to a media exposure computing device (MECD) 300 (discussed below in connection with FIG. 3) recorded travel path data 305 (i.e., the sequence of position fixes and received signals recorded by the device 200) via the download server 120.

It will be readily apparent to persons of ordinary skill in the art that the processor 220 of FIG. 2 may monitor and record into the storage memory 225 additional data concerning the operation, status, etc. of the device 200. For example, the processor 220 could monitor battery usage, device power-on and power-off times, software faults, etc.

To promote consistent and reliable determination of media exposure credits by the MECD 300, the travel path traversed by the respondent 102 will preferably be accurate (i.e., reflect actual locations traversed by the respondent 102), follow one or more known courses of travel (e.g., streets, roads, lanes, highways, interstates, bridges, sidewalks, pedestrians walkways, trails, tunnels, etc.), and contain position fixes that are sufficiently close together. However, as described above, the sequence of position fixes recorded by the device 200 (i.e., the recorded travel path data 305) may not always satisfy these requirements.

FIG. 3 is a schematic diagram illustrating an example MECD 300 constructed in accordance with the teachings of the invention that can be used to implement the example computing device 125 of FIG. 1. To post-process the recorded travel path data 305 and the media site information (contained in the database 130), the MECD 300 of FIG. 3 includes a pre-processor 308. The example pre-processor 308 of FIG. 3 includes a travel path processor 310 that operates on the recorded travel path data 305 (that contains both determined geographic locations and received signals (i.e., pseudorange data) recorded by the device 200 and provided via the download server 120) to generate enhanced travel path data 315. In the illustrated example, the recorded travel path data 305 and the enhanced travel path data 315 are stored in one or more memories and/or storage devices implemented as part of the MECD 300. It will be readily apparent to persons of ordinary skill in the art that the recorded travel path data 305 and the enhanced travel path data 315 may also be implemented in other ways. For example, using a memory or a storage device attached and configured to communicate with the MECD 300.

The travel path processor 310 processes the recorded travel path data 305 to enhance the completeness and accuracy of the position fixes. For example, the travel path processor 310 could derive position fixes (e.g., at locations where the device 200 could not determine a geographic location) using the recorded received SPS signals, increase the accuracy of position fixes determined by the device 200, etc. The travel path processor 310 may also include additional algorithms that compensate for other known SPS limitations, such as clock drift and multi-path signal distortions.

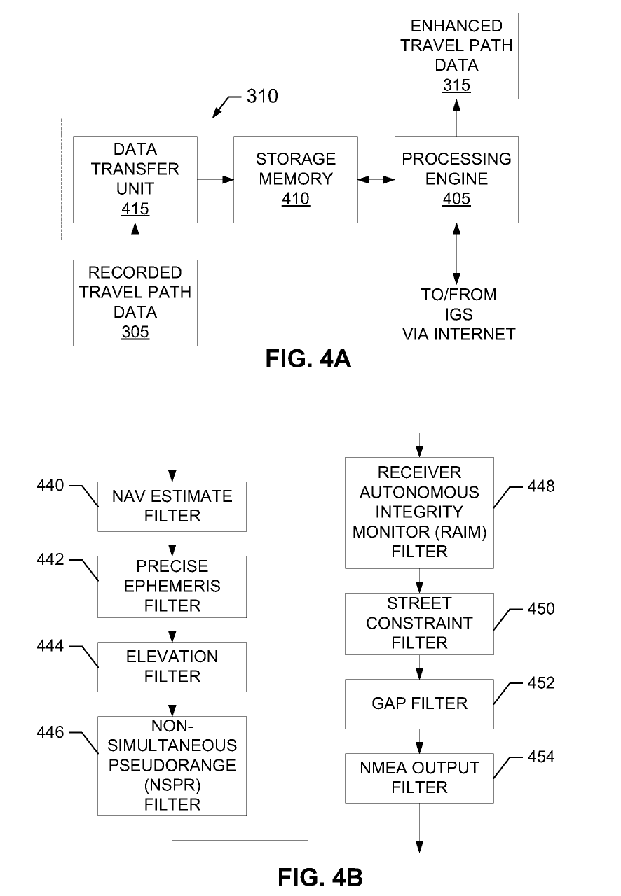

FIG. 4A illustrates an example manner of implementing the example travel path processor 310 of FIG. 3. To process the recorded travel path data 305, the example travel path processor 310 of FIG. 3 includes a processing engine 405 to operate on the recorded travel path data 305. For example, the processing engine 405 could be implemented as one or more filters operating sequentially and/or in parallel on the recorded travel path data 305. In the illustrated example of FIG. 4A, the processing engine 405 processes (e.g., applies a set of filters to) a set of data points representative of all or a portion of a travel path transferred into a storage memory 410 by a data transfer unit 415. The processing engine 405 operates on the set of data points, placing intermediate values (e.g., modified and/or additional data points created as outputs of a filter and used as inputs to a subsequent filter), if any, back into the storage memory 410. Final output data points are placed into the enhanced travel path data 315 by the processing engine 405.

As illustrated in FIGS. 3 and 4A, and discussed below in connection with an example precise ephemeris filter 442 (FIG. 4B), the example processing engine 405 of FIG. 4A can access data 395 provided by the International Geological Society (IGS) via an Internet connection 390. For example, the data 395 includes data precisely specifying the locations of SPS satellites 105A-C at known instants in time.

In the illustrated example of FIG. 4A, the storage memory 410 contains both recorded received SPS signals, position fixes determined by the device 200, and position fixes derived by the travel path processor 310. The data stored in the storage memory 410 may be stored using any of a variety of suitable techniques. For example, using object-oriented data storage techniques, using an array of data structures, etc.

The example processing engine 405 may be implemented using any of a variety of techniques. For example, the processing engine 405 could be implemented as software and/or firmware running on a general purpose processing device and/or a specialized processing device (e.g., a digital signal processing device), using hardware, or any combination of software, firmware and/or hardware.

It will also be readily apparent to persons of ordinary skill in the art that the storage memory 410 may be implemented using any of a variety of techniques. For example, using one or more portions of a memory or a storage device used to implement the recorded travel path data 305, or a separate memory, storage device and/or hardware registers directly associated with the travel path processor 310. Further, it will also be readily apparent to persons of ordinary skill in the art that the data transfer unit 415 could be eliminated. For example, the processing engine 405 could be configured to read the initial data points directly from the recorded travel path data 305.

FIG. 4B illustrates an example sequence of filters that may be used to implement the example processing engine 405 of FIG. 4A. In the illustrated example of FIG. 4B, the filters are implemented using object-oriented programming techniques, thereby, facilitating flexibility in the number, type, sequence, configuration, interconnections, etc. of the filters.

The example filter sequence illustrated in FIG. 4B begins with a NAV Estimate Filter 440 that creates an initial set of derived position fixes using the set of position fixes determined by the device 200. Using any of a variety of well-known techniques, a precise ephemeris filter 442 acquires the precise SPS satellite location data 395 (i.e., the ephemeris data 395) from the IGS via the Internet 390 and uses the ephemeris data 395 to improve the accuracy of pseudorange data (i.e., received SPS signals) recorded by the device 200. For example, the precise ephemeris filter 442 uses each time stamp recorded by the device 200 at each data point in the pseudorange data to interpolate between known positions of the SPS satellites 105A-C at known times (i.e., the ephemeris data 395) to determine precise satellite locations at the recorded time stamp instant. An elevation filter 444 then calculates, based on the satellite ephemeris data 395 and using standard orbital geometry principles, the angle above the horizon for each of the SPS satellites 105A-C associated with each pseudorange or position fix data point. To improve the accuracy of position fixes derived from the pseudorange data, the elevation filter 444 discards pseudorange data corresponding to ones of the SPS satellites 105A-C that are low relative to the horizon.

Next, a non-simultaneous pseudorange (NSPR) filter 446 locates missing position fix data points (e.g., representing locations where the device 200 was unable to determine a position fix), and derives additional position fixes. In an example, the NSPR filter 446 uses a set of pseudorange data points centered about a missing position fix data point and an interpolated clock drift value computed from the pseudorange data associated with the missing position fix data point and the nearest position fix data points to derive the missing position fix data point.

A receiver autonomous integrity monitor (RAIM) filter 448 processes the travel path to eliminate errors caused by multipath distortions. Multipath distortions are caused by the reception of an SPS transmit signal that has been reflected off of a plurality of surfaces located between one or more of the SPS satellites 105A-C and the device 200. Thus, the device 200 receives multiple versions of the SPS transmit signal, each having a different time delay and phase characteristic. In an example where a pseudorange data point contains signals from four or more SPS satellites, the RAIM filter 448 derives a position fix using each permutation of three of the SPS satellites. In particular, if four satellites (i.e., #1, #2, #3 and #4) are available, four position fixes are derived for the following combinations of satellites (#1 #2 #3), (#1 #2 #4), (#1 #3 #4), and (#2 #3 #4). In another example where a pseudorange data point contains signals from three SPS satellites (e.g., the satellites 105A-C), the RAIM filter 448 derives a position fix using each permutation of the three SPS satellites 105A-C and the last known position of a fourth SPS satellite (not shown). In both of the foregoing examples, the RAIM filter 448 compares the derived position fixes to each other. If the derived position fixes substantially concur, the position fix is included in the travel path. Otherwise, multipath distortion is deemed to have occurred and the position fix is removed from the travel path data.

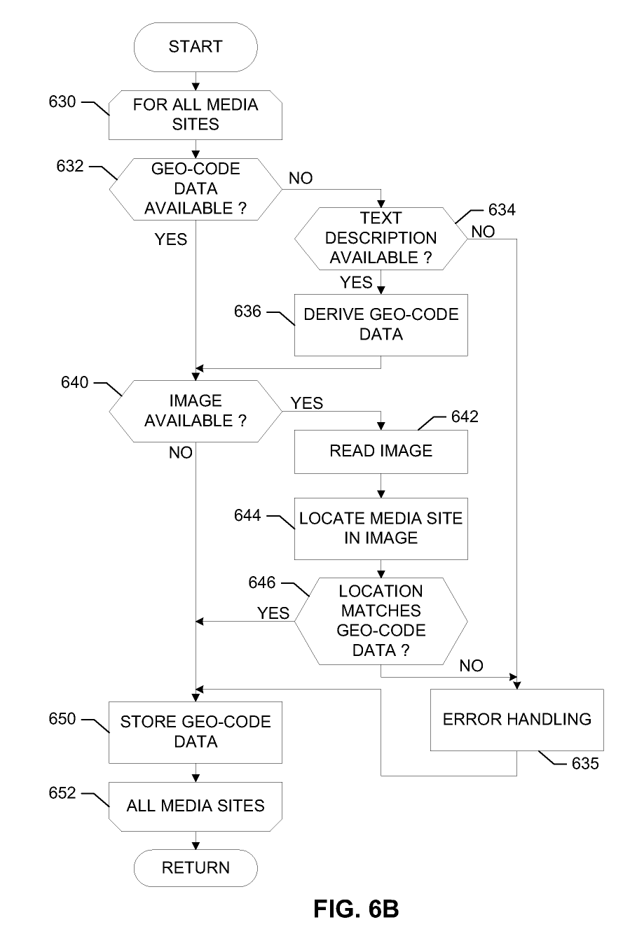

After having derived additional or improved the accuracy of existing position fixes, a street constraint filter 450 (discussed below in connection with FIGS. 7A-C, 8A-C, and 9A-G) aligns each position fix contained in the travel path to correspond with a centerline of a known course of travel. For example, the street constraint filter 450 modifies (i.e., aligns) a derived position fix to a closest point coinciding with a known course of travel (e.g., the centerline of the nearest road, sidewalk, etc.), where the closest point might be determined based on minimum Euclidean distance. However, such modifications may result in a travel path that skips or jumps around in an erratic or un-reasonable fashion (e.g., a travel path that moves back and forth between two sidewalks located on opposite sides of a street). To alleviate this problem, additional processing may be performed by the street constraint filter 450. The street constraint filter 450 may also process the travel path data to ensure consistency of motion. For example, the street constraint filter 450 could determine if travel speed indicates that the respondent 102 is in or on a vehicle and, if so, to ensure that the travel path is consistent with movements permitted by the immediate environment (e.g., bridges, over passes, under passes, one way streets, etc.).

A gap filter 452 derives additional position fixes such that the enhanced travel path data 315 consists of a sequence of position fixes in which each position fix is no more than a pre-determined distance (e.g., fifty feet) from a preceding and a following position fix. Additional position fixes are derived using any of a variety of standard geometric or trigonometric techniques that account for straight and curved travel paths and that ensure that the additional derived position fixes are aligned with a centerline of a known course of travel. Finally, the National Marine Electronics Association (NMEA) filter 454 outputs the enhanced travel path data 315 using a standard data format (e.g., the well-known NMEA-0183 format).

It will be readily apparent to persons of ordinary skill in the art that the number, sequence, type, configuration, etc. of the filters used to implement the processing engine 405 of FIG. 4A could be different from that shown in FIG. 4B. For example, a moving average filter could be used to compute a moving average of a sequence of position fixes to smooth noisy data. In particular, a moving average of each of the last n latitudes and the last n longitudes may be computed, where the latitudes and longitudes correspond to the coordinates of the last n position fixes. In another example, a clock drift interpolation filter models the drift in the clock used by the device 200 and applies time corrections to the pseudorange data. In a further example, a dead reckoning filter uses a previous position fix and an estimated respondent travel direction and velocity to estimate a position fix.

In yet another example, filters are arranged in two parallel paths. For instance, the travel path data 305 is split into two sets by a data sorting filter. A first set contains data points representing locations of the respondent 102 that occurred inside a geographic region containing large buildings (e.g., a downtown area), and a second set contains data points in more urban areas. Each set of data is then passed through one or more filters, where the filters applied to each set of data could be different or identical. Further, data could be exchanged between the two sets of filters (e.g., the two filter paths could be cross-coupled). A solution selector filter is then applied to combine the outputs of the two paths to create an overall travel path for the respondent 102.

When the respondent 102 travels through areas with obstructed SPS signal reception (e.g., subways, tunnels, parking garages, within buildings, etc.) the travel path processor 310 may operate to further improve the accuracy and reach of media exposure measurement systems. In an example, the processing engine 405 includes a gap detection filter configured to detect a large gap in the recorded position fixes and to detect that the large gap begins near a first subway entrance and ends nears a second subway entrance (due to the fact that current SPS technologies are not operable with devices that are located underground). If such a large gap is detected, then the gap detection filter configures the processing engine 405 to leave the large gap in the enhanced travel path data 315 but records information indicating that the gap likely corresponds to a route of a subway system located between the start and end of the gap. The gap detection filter can similarly detect and record other forms of signal obstructed travel, for example, through a vehicular or pedestrian tunnel, within a parking garage, etc. The above technique could be implemented for other types of, potentially obstructed, signals that may be used to determine the respondent's location.

As discussed below, the example MECD 300 can use the first and the second subway entrances to determine a likely route through the subway system connecting the two subway entrances. Having done so, the MECD 300 can credit media exposure to known media sites located along the subway route likely taken by the respondent 102, or located in subway cars transporting the respondent 102 along the subway route. Similarly, if the respondent 102 is exposed to media sites within other signal obstructed travel routes (e.g., within a vehicular or pedestrian tunnel, within a building structure, etc.), the media sites can be properly credited with media exposures.

Returning to FIG. 3, to handle media sites for which geo-code location data is missing from the database 130, or to verify geo-code location data present in the database 130, the pre-processor 308 of FIG. 3 further includes a media site processor 320.

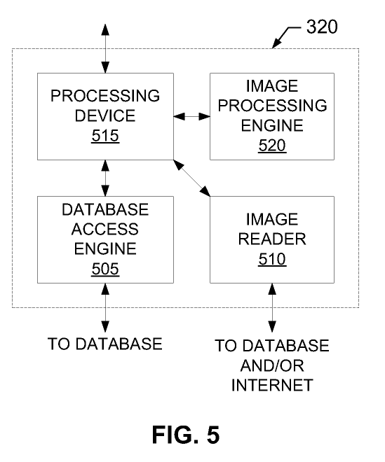

FIG. 5 illustrates and example manner of implementing the media site processor 320 of FIG. 3. The example media site processor 320 of FIG. 5 includes a database access engine 505 that communicates with the database 130 to obtain media site information (i.e., geo-code location data, a textual description of the media site location, media site type, etc.) and geo-code location data for known courses of travel, points of reference, landmarks, etc. The example media site processor 320 further includes an image reader 510 to access images of media sites that may be stored in the database 130 or which may be available via the Internet 390.

In an example, the media site processor 320 uses a textual description of the location of a media site together with information specifying known courses of travel, landmarks, points of reference, etc. to derive geo-code location data for the media site. An example media site has a textual location description indicating that the media site is located on the west side of 3^{rd} Street midway between State Street and Main Street. To derive geo-code locations, the example media site processor 320 includes a processing device 515. Knowing the geo-code location for the intersections of 3^{rd} and State, and 3^{rd} and Main, the processing device 515 interpolates between the two known geo-code locations to determine the geo-code location for the example media site.

In another example, the media site processor 320 verifies the accuracy of geo-code location data for a media site by comparing the geo-code location data to a digital representation of an image of the media site (e.g., a satellite image, an aerial photograph, etc.) using image recognition or matching techniques. For instance, the media site processor 320 may locate the media site in an aerial photograph of a portion of a city and then compare the location of the media site in the aerial photograph with available geo-code location data for the media site.

To locate media sites and other known points (e.g., known courses of travel, landmarks, points of reference, etc.) in an image, the media site processor 320 includes an image processing engine 520. In an example, using well-known suitable image recognition and/or matching techniques, the image processing engine 520 locates two intersections and a media site in an image. The image processing engine 520 then determines the relative locations of the intersections and the media site. For instance, the image processing engine 520 may determine that the media site is located one-third of the way between the two intersections.

Using the relative location information determined by the image processing engine 520, the processing device 515 can verify the geo-code location data for the media site. For instance, in the example described above, the processing device 515 uses the known geo-code location data for the two located intersections and the determination that the media site is located one-third of the way between the two intersections to derive geo-code location data for the media site. The processing device 515 may then compare the derived geo-code location data for the media site with already available geo-code location data for the media site (e.g., contained in the database 130, or determined by the processing device 515 based on a textual location description). If the geo-code location data match, the location of the media site is verified. Otherwise, the location of the media site may be flagged for further investigation and verification.

The processing device 515 and the image processing engine 520 could be implemented using any of a variety of techniques. For example, the processing device 515 and the image processing engine 520 could be implemented using software and/or firmware running on a general purpose processing device and/or a specialized processing device (e.g., a digital signal processing device), using hardware, or any combination of software, firmware and/or hardware. The determination of geo-code location data from a textual location description and verifying geo-code location data may be performed manually.

Returning again to the illustrated example of FIG. 3, the processed media site location data 325 is stored in one or more memories and/or storage devices implemented as part of the MECD 300. However, the processed media site location data 325 could also be implemented in other ways. For example, using a memory or a storage device attached and configured to communicate with the MECD 300, within the database 130, etc.

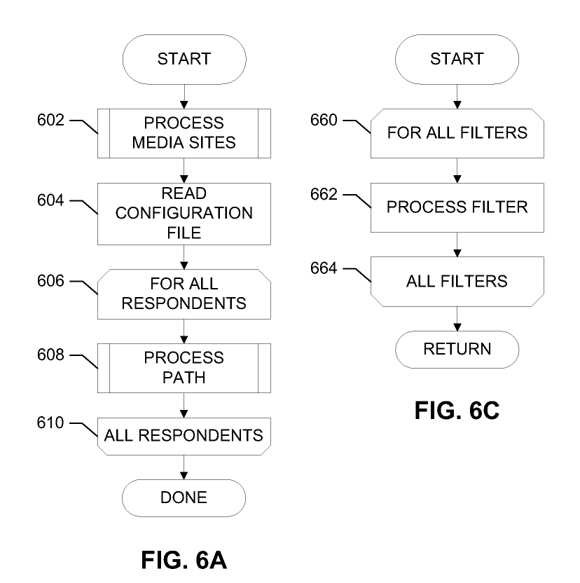

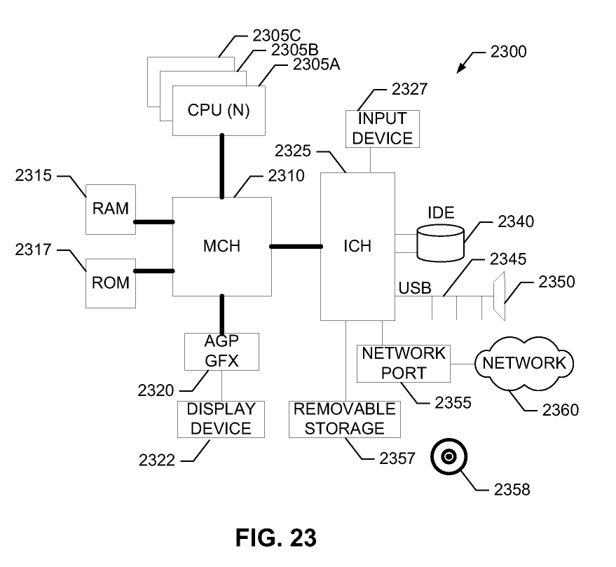

FIGS. 6A, 6B and 6C illustrate flowcharts representative of example machine readable instructions that may be executed by a processor (e.g., one of the processors 2305A-C of FIG. 23) to implement the example pre-processor 308 of FIG. 3, the travel path processor 310 of FIG. 3, and the media site processor 320 of FIG. 3, respectively. The machine readable instructions of FIGS. 6A-C, the example pre-processor 308, the example travel path processor 310 and/or the example media site processor 320 may be executed by a processor, a controller and/or any other suitable processing device. For example, the machine readable instructions of FIGS. 6A-C, the example pre-processor 308, the example travel path processor 310 and/or the example media site processor 320 may be embodied in coded instructions stored on a tangible medium such as a flash memory, or random access memory (RAM) associated with the processors 2305A-C shown in the example processor platform 2300 and discussed below in conjunction with FIG. 23. Alternatively, some or all of the example machine readable instructions of FIGS. 6A-C, the example pre-processor 308, the example travel path processor 310 and/or the example media site processor 320 may be implemented using an application specific integrated circuit (ASIC), a programmable logic device (PLD), a field programmable logic device (FPLD), discrete logic, hardware, software, and/or firmware. Also, some or all of the machine readable instructions of FIGS. 6A-C, the example pre-processor 308, the example travel path processor 310 and/or the example media site processor 320 may be implemented manually or as combinations of any of the foregoing techniques. Further, although the example machine readable instructions of FIGS. 6A-C are described with reference to the flowcharts of FIGS. 6A-C, persons of ordinary skill in the art will readily appreciate that many other methods of implementing the example pre-processor 308, the example travel path processor 310 and/or the example media site processor 320 may be employed. For example, the order of execution of the blocks may be changed, and/or some of the blocks described may be changed, eliminated, or combined.

The example machine readable instructions of FIG. 6A begin with the pre-processor 308 processing each media sites in the database 130 (block 602) using the example machine readable instructions of FIG. 6B. Although the pre-processor 308 is described as processing all of the media sites in the database 130, the pre-processor 308 may alternatively process only a portion of the media sites in the database 130. For instance, the pre-processor 308 may only process media sites associated with a particular demographic or market region (e.g., a city or metropolitan area).

In the example machine readable instructions of FIG. 6A, the pre-processor 308 then reads a configuration file that identifies which filters and filter configuration(s) are to be implemented by the travel path processor 310 (block 604). In an example, the configuration file is an XML file that identifies the types, order, sequence, configurations, interconnections, and number of the filters. However, other types and/or numbers of filters could be used instead.

The pre-processor 308 next processes the travel path data for each respondent (block 606) using the example machine readable instructions of FIG. 6C (block 608). If the travel path data for all respondents has been processed (block 610), the pre-processor 308 ends execution of the example machine readable instructions of FIG. 6A. Otherwise, the pre-processor 308 returns to block 606 to process the travel path for the next respondent.

The example machine readable instructions of FIG. 6B begin with the media site processor 320 processing each selected media site from the database 130 (block 630). For each media site, the processor 320 determines if geo-code location data is available (block 632). If geo-code location data for the media site is not available (block 632), the media site processor 320 determines if a textual location description for the media site is available (block 634). If a textual location description is not available (block 634), the media site processor 320 flags the media site for further processing (e.g., error handling) (block 635). Returning to block 634, if a textual location description is available, the media site processor 320 derives (as described above) geo-code location data based on the textual location description (block 636).

Returning to block 632, if geo-code location data is available, the media site processor 320 determines if an image containing the media site is available (block 640). In the example of FIG. 6B, the media site processor 320 determines if an image is available by checking for an image in the database 130 and/or via an Internet site. If an image is available (block 640), the media site processor 320 reads the image (block 642); locates the media site, and nearby landmarks, known courses of travel, points of reference, etc. with known geo-code location data; and determines geo-code location data for the media site based on the image (block 644). The media site processor 320 then determines if the geo-code location data determined from the image substantially matches the geo-code location data present in the database 130 or derived from a textual location description (block 646). If the geo-code location data substantially match (block 646), the media site processor 320 stores the geo-code location data in the media site location data 325 (block 650). Otherwise, if the geo-code location data does not substantially match (block 646), the media site processor 320 flags the media site for further processing (e.g., error handling) (block 635).

If all selected media sites have been processed (block 652), the media site processor 320 ends execution of the example machine readable instructions of FIG. 6B. Otherwise, if not all sites have been processed (block 652), the media site processor 320 returns to block 630 to process the next media site.

The example machine readable instructions of FIG. 6C begin with the travel path processor 310 operating each of the filters specified in the filter configuration file (discussed above) (block 660). The travel path processor 310 then operates one of the filters (block 662). If all filters have been operated (block 664), the media site processor 320 ends execution of the example machine readable instructions of FIG. 6C. Otherwise, if not all filters have been operated (block 664), the travel path processor 310 returns to block 660 to operate the next filter.

Returning to the street constraint filter 450 of FIG. 4B, each derived (or determined) position fix within a travel path is aligned (i.e., modified, manipulated, etc.) to correspond with a centerline of a known course of travel so that the resulting enhanced travel path data 315 represents consistent and reasonable travel paths along known courses of travel. The street constraint filter 450 determines, based on historical and future travel, an appropriate and most likely location of a position fix. In an example, the implementation of the street constraint filter 450 uses artificial intelligence (AI) algorithms and techniques (with appropriately chosen penalties and weights) to perform the various travel path manipulations. For instance, each of the position fixes may be mapped to multiple points corresponding to nearby known courses of travel to create a Bayesian tree representing multiple possible travel paths connecting the mapped position fixes. A value may then be applied to each point (e.g., based on the Euclidean distance from the actual position fix to the point). A cost associated with each path is determined by adding up the values for each of the mapped points comprising a path, and the path with the smallest cost is selected.

In the example of FIGS. 3 and 4B, the travel path processor 310 has access to geo-code data specifying the locations of known courses of travel. Further, the travel path processor 310 may use a street map file that defines the geographic or demographic region over which the street constraint filter 450 is to operate. Thus, portions of travel paths that traverse within or across the region will be processed by the street constraint filter 450. In the example of FIGS. 3 and 4B, the street map file is a configurable XML file that defines a simple bounding rectangle defined by four latitude and longitude pairs. The travel path processor 310 uses the bounding rectangle to determine the segments (e.g., 50 foot lengths) of each known course of travel that falls within the region. The travel path processor 310 operates to constrain position fixes to align with a centerline of one of the segments falling within the region.

FIG. 7A illustrates a portion of an example travel path that includes 20 derived position fixes (shown as circles 1-20). Within the example street constraint filter 450, a travel segment is an ordered set of consecutive data points that are associated with a particular known course of travel. For example, in FIG. 7A, Pine Street has three travel segments associated with it: (1, 2, 3, 4, 5), (13, 14, 15, 16) and (19, 20).

A deterministic path is constructed by forcing each position fix to be associated with only one segment of a known course of travel. FIG. 7B illustrates an example deterministic path constructed from the example travel path illustrated in FIG. 7A, where each node in the example deterministic path corresponds to one travel segment. If the street constraint filter 450 only considers deterministic paths, there is a substantial chance that the known course of travel that to which a point appears to be closest is not actually the known course of travel along which the respondent 102 was traveling. For example, in the example of FIG. 7A, position fix 17 could be associated with either 2^{nd} Street or Pine.

Instead of relying on deterministic paths, the example street constraint filter 450 constructs a decision tree that includes a plurality of mappings of the position fixes to possible known courses of travel. Thus, a decision tree consists of possible travel paths corresponding to the position fixes, where the complexity of the tree depends upon the amount of ambiguity in the position fixes (e.g., the number or percentage of ambiguous points). Each node in the decision tree represents a travel segment of a candidate travel path (i.e., a candidate segment). FIG. 7C illustrates an example decision tree containing two branches constructed from the example travel path data illustrated in FIG. 7A. The example decision tree of FIG. 7C is relatively small because the travel path data has a relatively low amount of ambiguity.

By constructing a decision tree, the street constraint filter 450 may employ fuzzy logic by applying a set of rules to determine the probability that each of the candidate travel paths comprising the decision tree was the actual travel path taken by the respondent 102. In particular, each candidate travel path is assigned a score, and the candidate travel path with the highest score is the travel path most likely taken by the respondent 102.

In the example street constraint filter 450, it recognized that a current position is most heavily influenced by the nearest neighboring positions. For example, in the example of FIG. 7A, whether position fix 17 should be on Pine or 2^{nd} is most affected by position fixes 16 and 18. Thus, the example street constraint filter 450 uses a predictor-corrector algorithm. For example, to determine the best known course of travel to map a position fix to, the example street constraint filter 450 iterates through the travel path data until a decision tree of a predetermined depth (e.g., four) is constructed. The example street constraint filter 450 then determines the score for each branch in the limited depth tree and selects the branch with the highest score. Having made a decision on a position fix (or candidate segment), the example street constraint filter 450 repeats the process for the next position fix (or candidate segment).

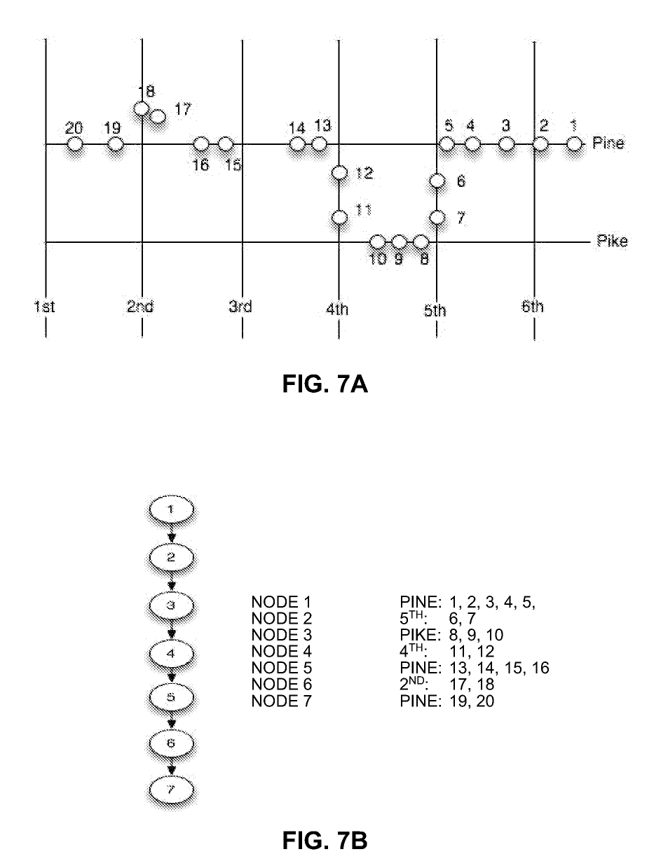

A variety of methods (i.e., metrics) could be used to score each branch of the limited depth decision tree. For example, the proximity of position fixes to a candidate segment, an apparent alignment of position fixes with respect to a candidate segment, etc. FIG. 8A illustrates additional example position fixes. An example metric is based on data moments, such as, for example, data moments taken about candidate segments. FIGS. 8B and 8C illustrate two moments of the example position fixes of FIG. 8A taken about 1^{st} and 2^{nd}, respectively. Candidate segments having a smaller average distance or moment are rated higher than those with a higher average distance or moment. In the example street constraint filter 450, the data moment is used as the initial score assigned to a candidate segment (i.e., node of the decision tree).

Another example metric is a dot product, which measures how well a candidate segment aligns with the corresponding position fixes. The dot product of the candidate segment and the position fixes determines an angle between the position fixes and the candidate segment. In this example, if the angle is close to 0 or 180 degrees the travel segment (i.e., decision tree node) is rated higher (i.e., receives a bonus), and if the angle is close to 90 or 270 degrees the travel segment is penalized.

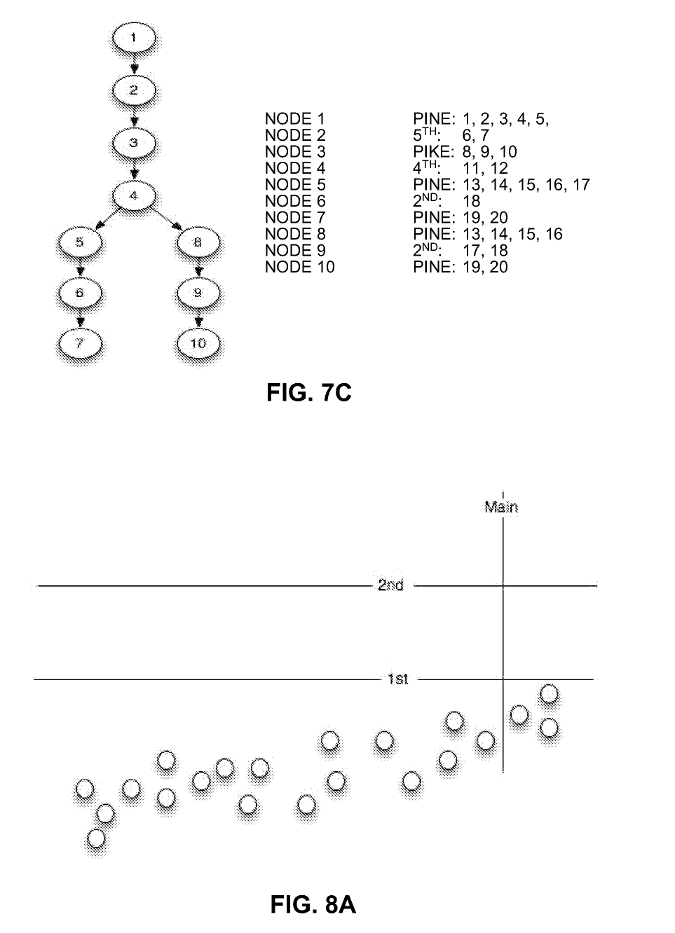

Yet another example metric utilizes contextual analysis based on candidate segments. For instance, consider a candidate segment s[n]. FIG. 9A lists some example contextual analysis bonuses that are awarded to the candidate segment s[n]. In particular, if s[n] has more than five consecutive points (i.e., position fixes), the candidate segment s[n] is awarded a 40% bonus (i.e., increases its score by 40%). If the score of a previous candidate segment s[n−1] is greater than a pre-determined amount (e.g., 60), the candidate segment s[n] is awarded a 10% bonus.

FIGS. 9B-G illustrate example candidate segment configurations that each result in a 15% contextual analysis penalty. For example, as illustrated in FIG. 9C, if the candidate segments s[n] and s[n+1] are not connected, a penalty of 15% is applied to the candidate segment s[n].

Returning again to FIG. 3, to determine if exposure of the respondent 102 to the media site 115 has occurred, the MECD 300 of FIG. 3 includes a passage processor 328. The passage processor 328 of the illustrated example of FIG. 3 uses the enhanced travel path data 315, the media site location data 325, and a set of constraints to determine if the respondent 102 passed the media site 115 (FIG. 1) in such a way that the respondent 102 had an opportunity to see the media site 115. For the media site 115 to be credited with media exposure in the illustrated example of FIG. 3, the respondent 102 must traverse within a geometric impact zone associated with the media site 115 in a direction favorable to viewing the media site 115.

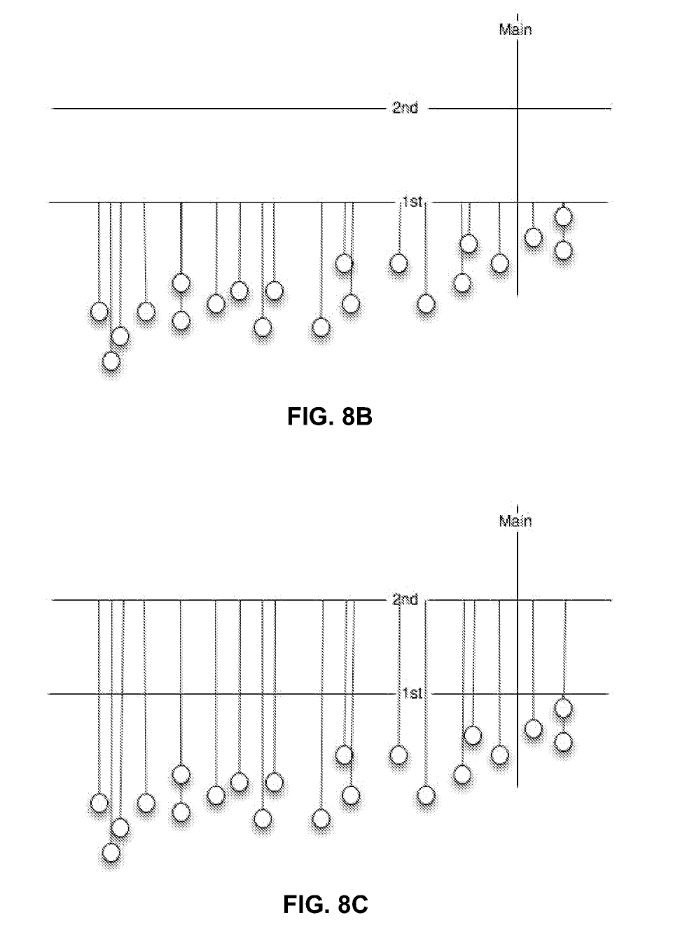

An example impact zone 1010 associated with the media site 115 is illustrated in FIG. 10. In the example of FIG. 10, the media site 115 faces northwest at an angle of 315 degrees. The example impact zone 1010 is a geometric region constructed as a portion of a circle 1005 having a radius equal to a maximum distance from which the media site 115 is viewable by the respondent 102, where the lines 1020 and 1025 represent the maximum angle over which the media site 115 is viewable by the respondent 102. The maximum viewable distance varies with the type and configuration of the media site 115. In the illustrated example of FIG. 10 the maximum viewable distance is directly related to and dependent on the site type (e.g., size of the media site). For example, a media site located on the side of a bus shelter is typically viewable from about 210 feet, and a 20 foot×60 foot bulletin board is typically viewable from about 1400 feet. Further, a maximum viewable distance associated with a media site may vary with the location of the media site, for example, a media site located 25 feet off the ground may be viewable over a longer distance. Alternatively, a maximum viewable distance could be associated with a media site that factors in specific fonts, colors, etc. utilized in the media site. Although the example impact zone 1010 is depicted as a portion of a circle, the impact zone 1010 could be constructed as a geometric region having a different shape, such as, for example, a rectangle.

In the illustrated example of FIG. 10, the maximum viewable angle is 140 degrees centered about a vector 1013 that lies along the direction the media site 115 is facing (i.e., 315 degrees). Thus, the line 1020 corresponds to 25 degrees (i.e., (315±70)% 360 degrees) and the line 1025 corresponding to 245 degrees (i.e., (315-70)% 360 degrees), where the symbol % signifies the modulo operator. However, for some media sites, a maximum viewable angle is 180 degrees. This corresponds to the line 1020 being aligned with a 45 degrees line, and the line 1025 being aligned with a 225 degrees line. For the media site 115 to be credited with a media exposure, the respondent 102 must pass through or traverse within the impact zone 1010 associated with the media site 115 in a favorable direction.

Directions of travel favorable to seeing or consuming the media site 115 depend upon the direction the media site 115 is facing and a maximum respondent visibility angle. The maximum respondent visibility angle is the angular range over which the respondent 102 can see or consume the media site 115 without turning their head. For example, 65 degrees is typical of what most respondents can see when seated in a car and restricted by a car windshield, and 50 degrees is what research has shown to be the range over which 90% of human vision is performed. In particular, for the media site 115 facing X degrees and a maximum respondent visibility angle of Y degrees, favorable directions of travel include directions of travel between [(X−(Y/2)+180) % 360] degrees and [(X+(Y/2)+180) % 360] degrees, where the symbol % signifies the modulo operator. Thus, with a maximum respondent visibility angle of 140 degrees, favorable directions of travel in the illustrated example of FIG. 10 are between 65 degrees and 205 degrees.

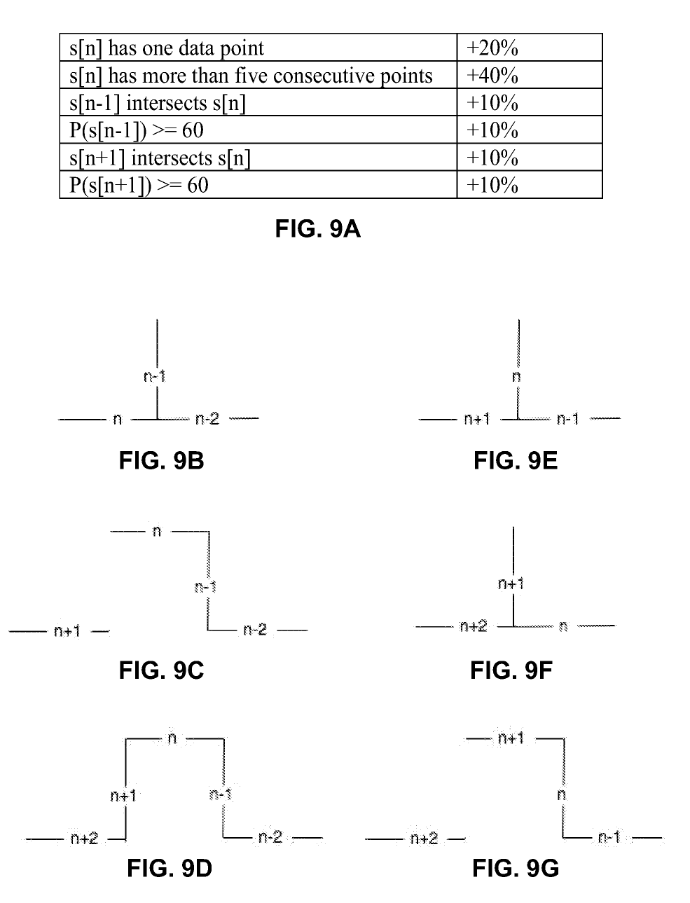

FIG. 11 illustrates a straight travel path 1105 traversing within the example impact zone 1010 of FIG. 10 at 90 degrees (due east). A portion of the straight path 1105 shown as arrow 1110 does not result in the media site 115 being credited with media exposure because the respondent 102 is outside the impact zone 1010 (hashed areas). Portions of the travel path 1105 shown as a plurality of bold arrows 1115 through 1120 result in the media site 115 being credited with media exposure as the respondent 102 is traversing within the impact zone 1010 in a direction favorable to viewing the media site (i.e., 65 degrees<90 degrees<205 degrees). The remaining portion of the travel path 1105 represented by arrow 1125 does not result in the media site 115 being credited with media exposure because the respondent 102 has left the impact zone 1010.

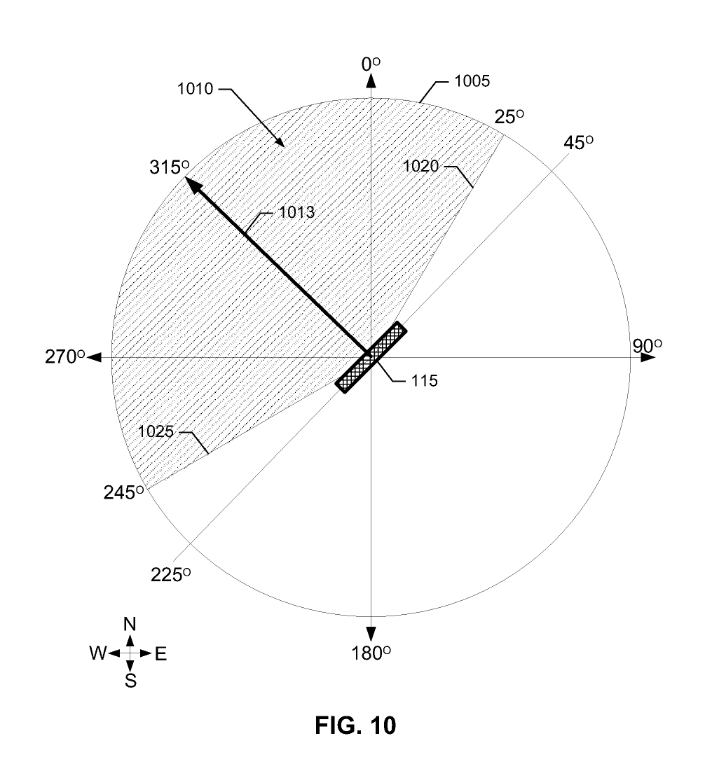

FIG. 12 illustrates a curved travel path 1205 traversing through and within the example impact zone 1010 of FIG. 10. The portions of the travel path 1205 traversing within the impact zone 1010 (hashed areas) in a favorable travel direction are shown as bold arrows.

With reference to FIG. 3, to compute the impact zone 1010 associated with the media site 115, the passage processor 328 includes an impact zone computing device 330 that computes the impact zone 1010 based on the maximum viewable distance and the maximum viewable angle associated with the media site 115 as recorded in the media site location data 325. To determine if the respondent 102 traverses the impact zone 1010 computed by the impact zone computing device 330, the passage processor 328 includes a location comparing device 335 that compares position fixes in the enhanced travel path data 315 to determine if they fall within the impact zone 1010. The impact zone computing device 330 also computes the range of favorable viewing directions for the media site 115 based on the direction the media site 115 is facing and the maximum respondent visibility angle. A range of favorable viewing directions for the media site 115 may be computed for a maximum respondent visibility angle applicable for all respondents. Alternatively, a range of favorable viewing directions for the media site 115 may be computed for each respondent, thereby, facilitating a maximum respondent visibility angle for each respondent.

To determine travel directions, the passage processor 328 includes a travel direction computing device 340 that computes a direction of travel for position fixes that fall within the impact zone 1010. The position fixes that fall within the impact zone 1010 are provided to the travel direction computing device 340 by the location comparing device 335. The travel direction associated with a position fix is determined using at least one other position fix and using standard geometric principles. For example, by constructing a vector connecting the position fix to a next position fix and determining the direction associated with the constructed vector.

The passage processor 328 further includes a direction comparator 345 that compares the direction of travel for position fixes that fall within the impact zone 1010 to the range of favorable travel directions computed by the impact zone computing device 330.

Each media site is treated independently, even media sites that are located proximate to each other, and each media site is associated with an impact zone and with favorable directions of travel. For example, in the case of two bulletin boards positioned back-to-back and perpendicular to a highway, one bulletin board is credited with viewing by respondents traveling in one direction and the other with viewing by respondents traveling in the opposite direction.

As discussed in greater detail below, additional constraints (e.g., site illumination, exiting and re-entering impact zones, etc.) may be applied such that the media site 115 may not be credited with exposure for the respondent 102 located at a position fix, even though that position fix meets the impact zone and the favorable travel direction constraints, i.e., is located within the impact zone and the respondent 102 is moving and/or facing in a favorable travel direction. For example, if the respondent 102 passes the media site 115 during non-daylight hours and the media site 115 is not illuminated, the media site 115 would not be credited with exposure. To apply additional constraints, the passage processor 328 includes a constraint processor 350. Each exposure credited to the media site 115 is recorded by the constraint processor 350 in the database 130.

Media site information present in the database 130 specifies whether or not a media site 115 is illuminated and, if illuminated, the hours of illumination. For example, some media sites are not illuminated and, thus, are only credited with media exposure during daylight hours. For example, daylight hours include approximately the 12 hours (6 am-8 pm) during winter months (April to September) in Chicago, Ill. Alternatively, daylight hours could be determined on a daily basis using a meter capable of measuring natural lighting conditions, or using meteorological data indicating sunrise and sunset times. For an illuminated media site 115, the media site 115 may be credited with media exposure identically during daylight and portions of the day during which the media site 115 is illuminated. Additionally or alternatively, a credit given to viewing of the media site 115 by a respondent having a medical condition that causes or results in reduced vision such as, for example, night blindness, may be adjusted to account for this vision condition or any other vision condition that is known to affect the respondent's ability to view media from a distance.

When a respondent 102 has multiple sequential position fixes that fall within the impact zone 1010, the media site 115 is only credited with a single exposure. In particular, if 150 or more consecutive position fixes are located within 50 feet (with up to 5 exceptions), then the sequence of position fixes is considered a cluster and only a single exposure is credited. If more than 5 points in the consecutive list are more than 50 feet apart then multiple exposures are credited.

To address situations in which the respondent 102, who may be near an edge of the impact zone 1010, passes into and out of the impact zone 1010 numerous times, an additional constraint is applied. If the respondent 102 leaves the impact zone 1010 and then re-enters the impact zone 1010, the media site 115 is not credited with an additional exposure unless the respondent 102 has left the impact zone 1010 for a minimum period of time. In the illustrated example, the minimum period of time is 10 minutes. However, any other period of time could be used instead.

Often, the media site 115 is located along one road (i.e., a primary road) while the respondent 102 is traveling in a favorable direction along a second road (i.e., a secondary road) and enters the impact zone 1010 of the media site 115. The constraint for handling this situation may vary with the location of the media site 115. In the illustrated example, media exposure is only credited to the media site 115 if the respondent 102 is traveling on the primary road or a pre-determined list of secondary roads, where the pre-determined list of secondary roads includes secondary roads from which the media site 115 is viewable and that have been requested by a owner of the media site 115 to be included in the list. Alternatively, the media site 115 could be classified based upon whether or not it is surrounded by tall buildings (e.g., downtown areas) that may affect viewing of the media site 115. For example, if the media site 115 is surrounded by tall buildings, the media site 115 might only be credited with media exposure if the respondent 102 is traveling on the primary road or if the media site 115 is located on a rooftop and, thus, is viewable from secondary roads. If the media site 115 is not surrounded by tall buildings, media exposure is credited to the media site 115 regardless of whether the respondent 102 is traveling on a primary or secondary road.

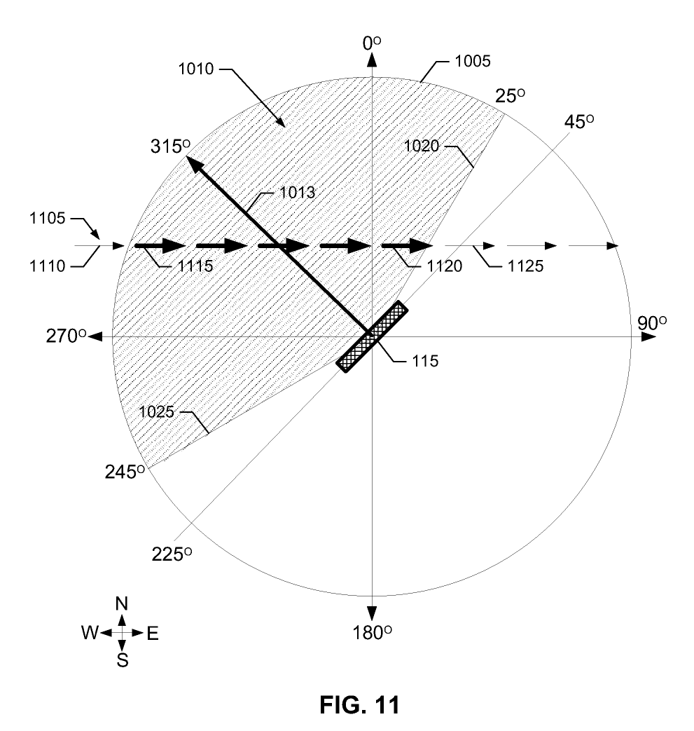

The example methods discussed above can be used to determine media exposure for mobile media sites (such as, for example, media on the side of a vehicle). For example, the majority of buses have four possible messages (i.e., media sites) per bus—one on each side of the bus (i.e., front, back, passenger side, driver side). FIG. 13 is a diagram illustrating four impact zones 1310, 1315, 1320, and 1325 created around a bus 1305. If other media positioning arrangements are utilized (e.g., a single message across the entire bus), the methods outlined below can be modified in ways readily apparent to persons of ordinary skill in the art.

In the illustrated example of FIG. 13, the respondent 102 can see only one of the four messages at any given point in time. Thus, the bus 1305 is divided into four quadrants, each of which corresponds to a side of the bus 1305. To illustrate this, one can imagine standing on the roof of the bus 1305 facing in a direction of travel of the bus 1305. If the letter ‘X’ is drawn on the roof, then each of four quadrants formed by the ‘X’ is assigned to one of the four messages. In the illustrated example of FIG. 13, the four quadrants correspond to the four impact zones 1310, 1315, 1320 and 1325, respectively. It should be readily appreciated by those of ordinary skill in the art that other impact zone shapes could be used. For instance, if the messages have a maximum viewable angle of 180 degrees then impact zones may overlap and the respondent 102 may see two messages or media displays at the same time. The favorable directions of travel for each of the messages for the bus 1305 may be computed in a manner similar or identical to those for fixed media sites.

For a fixed location media site, the precise location of the media site 115 is determined by the geo-code location data found in the media site location data 325. However, in the case of the bus 1305, the coordinates of the bus 1305 may be changing since the bus 1305 may be either stopped or in motion between stops. Although buses are in near constant motion, each bus route has pre-specified scheduled stop locations and times. Thus, a travel path of the bus 1305 may be simulated using the pre-specified scheduled stop locations and times, and a bus route assigned to the bus 1305. The geo-code location data for each scheduled stop location is easily obtainable using any of a variety of well-known techniques. From these known fixed locations, the impact zones 1310, 1315, 1320, and 1325 around the bus 1305 stopped at a bus stop may be treated as four stationary outdoor media sites (e.g., a bulletin or a bus shelter) for a specific period of time and the methods for determining media exposure discussed above can be applied. In particular, any passage through one of the impact zones 1310, 1315, 1320 and 1325 in a favorable direction by the respondent 102 during the time that the bus 1305 is stopped at the bus stop could be recorded as a media exposure.

At the end of each scheduled bus stop, the impact zones 1310, 1315, 1320, and 1325 move in the same direction as bus 1305. As the bus 1305 moves forward, new impact zones are created along the simulated travel path representing an additional set of stationary media sites having impact zones that are contiguous to the impact zones 1310, 1315, 1320 and 1325 associated with the bus stop. The size of these new impact zones is the same as the original set of impact zones 1310, 1315, 1320 and 1325. Any traversing by the respondent 102 within these new impact zones during a prescribed window of time, may result in the associated message being credited with viewing, wherein the prescribed window of time is determined based on the estimated location of the bus 1305 at a given time. In other words, the impact zones would be created at each bus stop using the bus schedule. Between any two known bus stops, virtual bus stops (and associated impact zones) may be created such that the impact zones are contiguous between the known bus stops and lie along the simulated travel path of the bus 1305. The start and end times used for each virtual stop may be computed by interpolating the known times between scheduled stops. This method allows for the possibility of media exposure credit at any time the bus 1305 is scheduled to be on a route, and at any location throughout the bus route. Alternatively, the impact zones may be treated as continuously moving impact zones rather than being quantized into segments

As illustrated in FIG. 13, the distance from which a headlight sign (on the front of the bus 1305) can be seen is approximately 50 feet in front of the bus 1305, the bus is about 25 feet long, and a tail light sign can be seen from about 75 feet behind the bus. Thus, in the example of FIG. 13, the total street distance of 150 feet is used as the length of the segments.

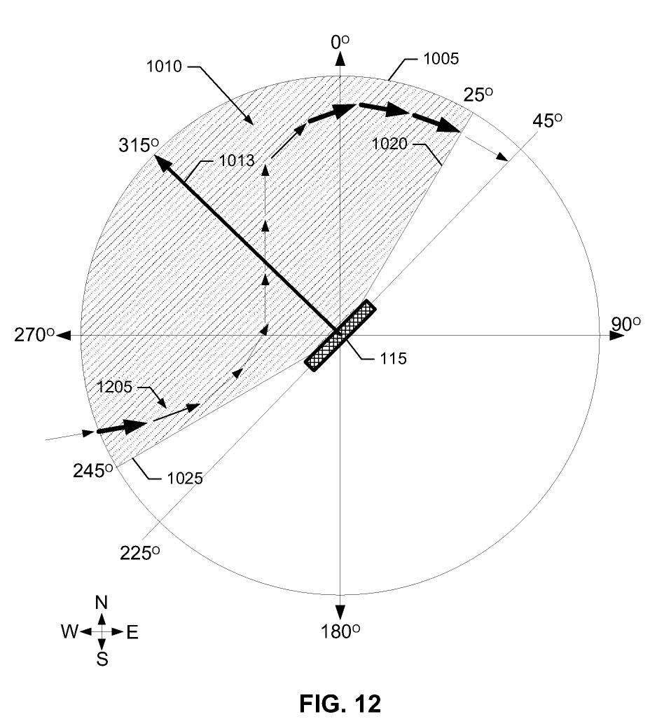

FIG. 14 illustrates an example scenario involving three city blocks including a bus stop at the first and third blocks of this picture (stops #14 and #15 on the route), and two virtual stops 1405 and 1410 between the known stops, resulting in four non-overlapping impact zones for the front of the bus 1305, four impact zones for the driver side of the bus 1305, etc.

The same constraints associated with illumination discussed above for fixed media sites can be applied to mobile media sites. Further, the bus 1305 could be equipped with SPS devices to record actual bus locations rather than deriving bus locations from associated bus schedules. In that case, the actual bus location data may be used to derive an impact zone and to identify favorable travel directions for any position and/or any number of positions (depending on the desired granularity of the data) at which the bus 1305 is located at any point in time.

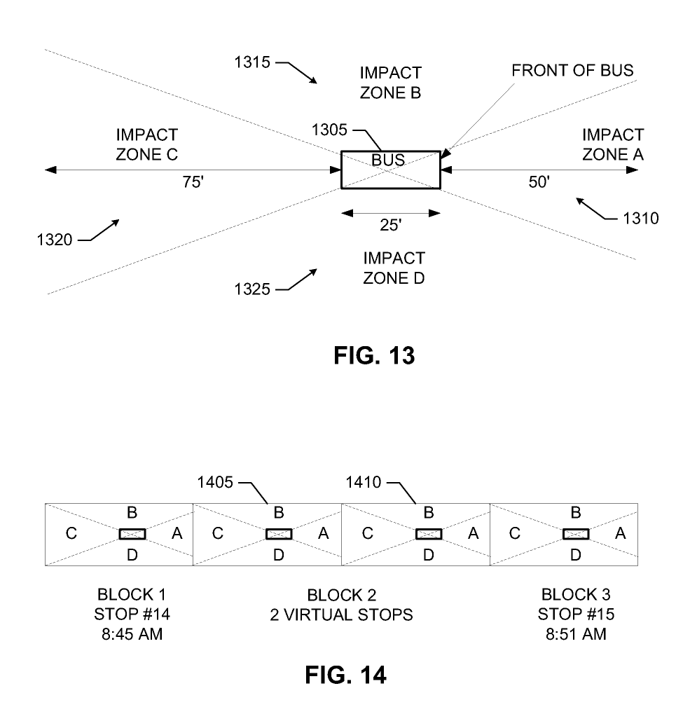

FIGS. 15, 16 and 17 illustrate flowcharts representative of example machine readable instructions that may be executed by a processor (e.g., one of the processors 2305A-C of FIG. 23) to implement the example passage processor 328 of FIG. 3. The machine readable instructions of FIGS. 15-17 and/or the example passage processor 328 of FIG. 3 may be executed by a processor, a controller and/or any other suitable processing device. For example, the machine readable instructions of FIGS. 15-17 and/or the example passage processor 328 of FIG. 3 may be embodied in coded instructions stored on a tangible medium such as a flash memory, or random access memory (RAM) associated with the processors 2305A-C shown in the example processor platform 2300 and discussed below in conjunction with FIG. 23. Alternatively, some or all of the example machine readable instructions of FIGS. 15-17 and/or the example passage processor 328 of FIG. 3 may be implemented using an application specific integrated circuit (ASIC), a programmable logic device (PLD), a field programmable logic device (FPLD), discrete logic, hardware, software, and/or firmware. Also, some or all of the machine readable instructions of FIGS. 15-17 and/or the example passage processor 328 of FIG. 3 may be implemented manually or as combinations of any of the foregoing techniques. Further, although the example machine readable instructions of FIGS. 15-17 are described with reference to the flowchart of FIGS. 15-17, persons of ordinary skill in the art will readily appreciate that many other methods of implementing the example passage processor 328 of FIG. 3 may be employed. For example, the order of execution of the blocks may be changed, and/or some of the blocks described may be changed, eliminated, or combined.

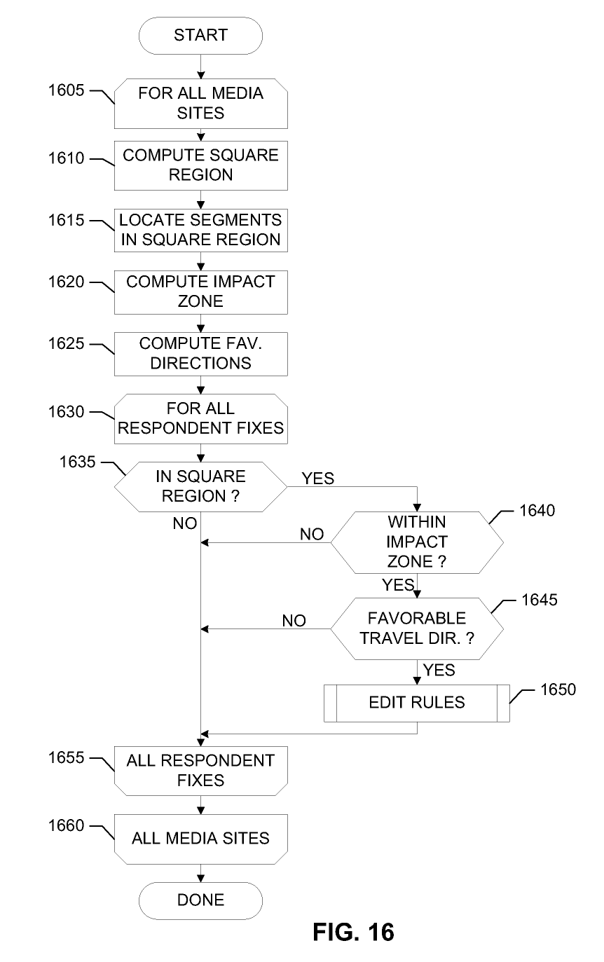

The example passage processor 328 begins execution of the example machine readable instructions of FIG. 15 with block 1505 where all media sites are processed. The passage processor 328 computes the impact zone 1010 associated with the media site 115 based on the maximum viewing distance, the facing direction, and the maximum viewing angle of the media site 115 (block 1510). The passage processor 328 then computes the range of favorable traveling directions (block 1515). As discussed above, the range of favorable travel directions could correspond to a common maximum respondent visibility angle, or be associated with a maximum respondent visibility angle for each respondent. The passage processor 328 continues with block 1520 where all position fixes associated with all respondents are processed. For a position fix, the passage processor 328 compares the position fix with the impact zone 1010 (block 1525). If the position fix falls within the impact zone 1010 (block 1525), the passage processor 328 compares a travel direction of the respondent 102 at the position fix with the range of favorable travel directions associated with the media site 115 (block 1530). If the travel direction of the respondent 102 is favorable (block 1530), the passage processor 328 applies additional applicable constraints by executing the example machine readable instructions of FIG. 17 (block 1532).

Returning to block 1525, if the position fix does not fall within the impact zone 1010, the passage processor 328 determines if all position fixes have been processed (block 1535). If all position fixes have not been processed (block 1535), the passage processor 328 returns to block 1520 to process the next position fix. Otherwise, if all position fixes have been processed (block 1535), the passage processor 328 determines if all media sites have been processed (block 1540). If all media sites have been processed (block 1540), the passage processor ends execution of the example machine readable instructions of FIG. 15. Otherwise, if not all media sites have been processed (block 1540), the passage processor 328 returns to block 1505 to process the next media site.

To determine media exposure for mobile media sites (e.g., bus 1305), the block 1505 of FIG. 15 includes the plurality of temporary impact zones associated with mobile media sites. Additionally, the determination of whether the respondent 102 is inside a temporary impact zone (block 1525) factors in the valid time period for each temporary impact zone.

For a portion of a travel path associated with obstructed signal reception, an additional decision block may be added prior to block 1525 in the example machine readable instructions of FIG. 15. The additional decision block detects a gap in position fixes associated with obstructed signal reception (as marked by the pre-processor 308 of FIG. 3 in the enhanced travel path data 315). If a gap is detected, the passage processor 328 determines a likely route for the portion of the travel path associated with the obstructed signal reception and credits media sites located along the likely route with media exposures.

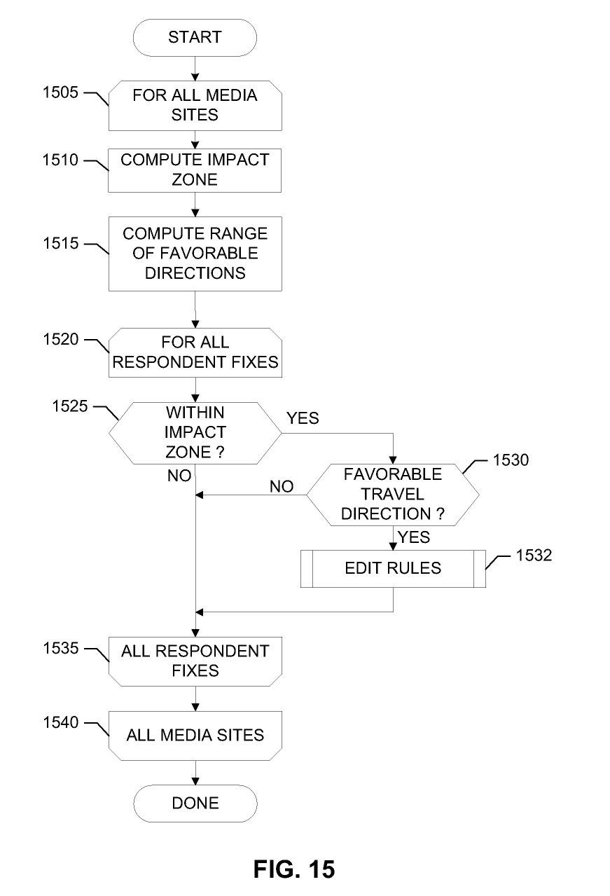

A more computationally efficient implementation of the example machine readable instructions illustrated in FIG. 15 is shown in the alternative example machine readable instructions of FIG. 16. The example machine readable instructions of FIG. 16 take advantage of the fact that respondent travel paths are aligned to fall along known courses of travel and that less computation is required to determine whether a segment of a known course of travel falls within a square than within a circle.

The passage processor 328 begins execution of the alternative example machine readable instructions of FIG. 16 with block 1605 where all media sites are processed. The passage processor 328 computes a square region centered on the media site 115 such that each side of the square region has a length approximately equal to twice the maximum viewing distance of the media site 115 (block 1610). However, other lengths or distances could be used instead. Additionally, the region could be rectangular or another polygonal shape rather than square such that it roughly corresponds to the dimensions of the impact zone 1010 associated with the media site 115. The passage processor 328 also determines a list of segments associated with known courses of travel that fall within the square region (block 1615).

The passage processor 328 then computes the impact zone 1010 associated with the media site 115 based on the maximum viewing distance, the facing direction, and the maximum viewing angle of the media site 115 (block 1620). The passage processor 328 next computes favorable traveling directions (block 1625). As discussed above, the favorable travel directions could correspond to a common maximum respondent visibility angle, or be associated with a maximum respondent visibility angle for each respondent.

The passage processor 328 continues with block 1630 where all position fixes associated with all respondents are processed. For a position fix, the passage processor 328 compares the position fix (which has been aligned with a segment of a known course of travel) with the list of segments of known courses of travel contained within the square region (block 1635). If the position fix falls on one of these segments (block 1635), the passage processor 328 compares the position fix with the impact zone 1010 (block 1640). If the position fix falls within the impact zone 1010 (block 1640), the passage processor 328 compares a travel direction of the respondent 102 at the position fix with the favorable travel directions associated with the media site 115 (block 1645). If the travel direction of the respondent 102 is favorable (block 1645), the passage processor 328 applies additional applicable constraints using the example machine readable instructions of FIG. 17 (block 1650). Otherwise, if the travel direction of the respondent 102 is not favorable (block 1645), the passage processor 328 proceeds to block 1655.

If all position fixes have not been processed (block 1655), the passage processor 328 returns to block 1630 to process the next position fix. Otherwise, if all position fixes have been processed (block 1655), the passage processor 328 determines if all media sites have been processed (block 1660). If all media sites have been processed (block 1660), the passage processor ends execution of the example machine readable instructions of FIG. 16. Otherwise, if not all media sites have been processed (block 1660), the passage processor 328 returns to block 1605 to process the next media site.

The passage processor 328 begins execution of the example machine readable instructions of FIG. 17 by comparing a time of day associated with a position fix with the daylight hours associated with the media site 115 (block 1705). If the time of day falls outside of the daylight hours of the media site 115 (block 1705), the passage processor 328 determines if the time of day falls within the illumination hours (if any) of the media site 115 (block 1707). If the passage processor 328 determines that the site is not illuminated at the time of day associated with the position fix (block 1707), then the passage processor 328 ends execution of the example machine readable instructions of FIG. 17 because without daylight conditions (block 1705) or site illumination (block 1707), the media site 115 was not likely to be seen by the respondent 102.

If either daylight conditions exist (1705) or the media site 115 is artificially illuminated at the time of day associated with the position fix (block 1707), then the passage processor 328 determines if the travel path includes multiple position fixes that are located inside the impact zone 1010 (block 1710). If multiple position fixes are located within the impact zone 1010 (block 1710), then the passage processor 328 determines if the respondent 102 has been outside the impact zone 1010 for at least 10 minutes since a last time at which the respondent 102 was located within the impact zone 1010 (block 1715). If the respondent 102 has not been outside the impact zone 1010 for at least 10 minutes (block 1715), the passage processor 328 ends execution of the example machine readable instructions of FIG. 17. It will be readily apparent to persons of ordinary skill in the art that any other period of time could be used instead of ten minutes and, preferably, the length of the time period is related to a likelihood that someone outside of the impact zone 1010 for the prescribed length of time focuses their viewing attention on the media site 115 upon reentering the impact zone 1010 such that a separate exposure credit is appropriate.

If there are not multiple position fixes in the impact zone 1010 (block 1710) or if the respondent 102 has been out of the impact zone 1010 for more than 10 minutes (block 1715), the passage processor 328 determines if the position fix falls along the primary road associated with the media site 115 (block 1720). If the position fix falls along the primary road (block 1720), then the passage processor 328 credits the exposure to the media site 115 (block 1725) and ends execution of the example machine readable instructions of FIG. 17.

Returning to block 1720, if the position fix does not fall along the primary road, the passage processor 328 determines if the position fix falls along a pre-determined secondary road from which the media site 115 is viewable (block 1730). If the position fix falls along a pre-determined secondary road from which the media site 115 is viewable (block 1730), then the passage processor 328 credits the exposure to the media site 115 (block 1725) and ends execution of the example machine readable instructions of FIG. 17. Otherwise, if the position fix does not fall along a pre-determined secondary road from which the media site 115 is viewable (block 1730), the passage processor 328 ends execution of the example machine readable instructions of FIG. 17 without having credited the media site 115 with exposure to the respondent 102. Alternatively, the example machine readable instructions of FIG. 17 can only credit the media site 115 with exposure for travel on the primary road by skipping the decision block 1730.

Statistical sampling errors are inherent to any media exposure rating systems. For example, errors may be caused when the statistical demographics of a plurality of respondents 102 do completely not match the demographics of a marketing region; the number of respondents 102 was not large enough to ensure that all media sites 115 were passed; a particular respondent 102 lives close to a few media sites 115, and thus exposure credits are overly high for those media sites 115; etc. Further, the pool of respondents 102 may not have provided a full set of demographic data.

Returning to FIG. 3, to improve the statistical accuracy and/or representativeness of the media exposure credits (i.e., passage data) determined by the passage processor 328 and stored in the database 130, the MECD 300 includes a statistics processing device 397. The statistics processing device 397 employs statistical analysis algorithms to harmonize the passage data to be more representative of a larger pool of respondents, impute missing demographic values, and/or create reach and frequency values that represent the effectiveness of media sites. However, it will be readily apparent to persons of ordinary skill in the art that it is important that any statistical processing implemented by the statistics processing device 397 ensures that the resulting passage data (and any resulting reach and frequency values derived there from) remain an unbiased estimate of media site exposure in each measured market or region.

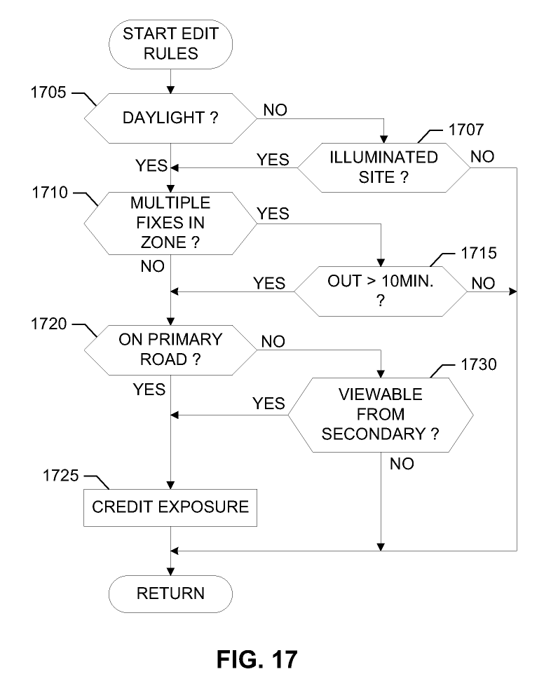

FIG. 18 illustrates an example manner of implementing the statistics processing device 397 of FIG. 3. To harmonize the passage data, the statistics processing device 397 includes a data harmonization processor 1805. The harmonization processor 1805 seeks to remove extreme characteristics of the passage data (including sites with zero or abnormally high passage data) and to smooth the passage data, while maintaining the overall average media site passage estimates for each media site owner and media site type.

In the outdoor media marketplace, alternative media site passage estimates based on surveys of automobile traffic are available (e.g., TAB daily effective circulation (DEC) passage estimates). Surveys relying on automobile traffic are different in definition, data method, and timing from the example electronic media site exposure system illustrated in FIG. 1. However, statistical analysis and comparison of results indicate that results from the two techniques are typically within +/−20% of each other for most media sites.

In an example, the harmonization processor 1805 modifies the passage data in an iterative fashion. In each iteration, the harmonization processor 1805 constrains the passage data to be within +/−20% of the TAB DEC passage data and factors the constrained passage data to restore the average passage value (i.e., the passage data is constrained to maintain the average). In particular, to factor the constrained passage data, the data harmonization processor 1805 computes the current average, determines a scale factor as the original average divided by the current average, and multiplies the constrained passage data by the scale factor. In this example, maintaining the average passage is of primary importance, and, thus, if the two constraints can not be met simultaneously, the percentage constraint is relaxed. For media sites with no DEC TAB data, a simple weighted average is applied by the statistics processing device 397 to smooth the passage data. The statistics processing device 397 ends the iterations when either a maximum number of iterations have occurred or convergence has been detected. In this example, convergence is determined by monitoring the percentage error between the current average passage and the original average passage. When the percentage falls below a pre-determined limit, convergence has occurred. Other techniques for passage data harmonization could be used instead of or in addition to those described above. For example, harmonization with other media site exposure survey data could be used, a different target percentage could be used, a different convergence criteria could be used, etc. Further, the passage data may be modified by the statistics processing device 397 to satisfy any number of constraints (including a single constraint).

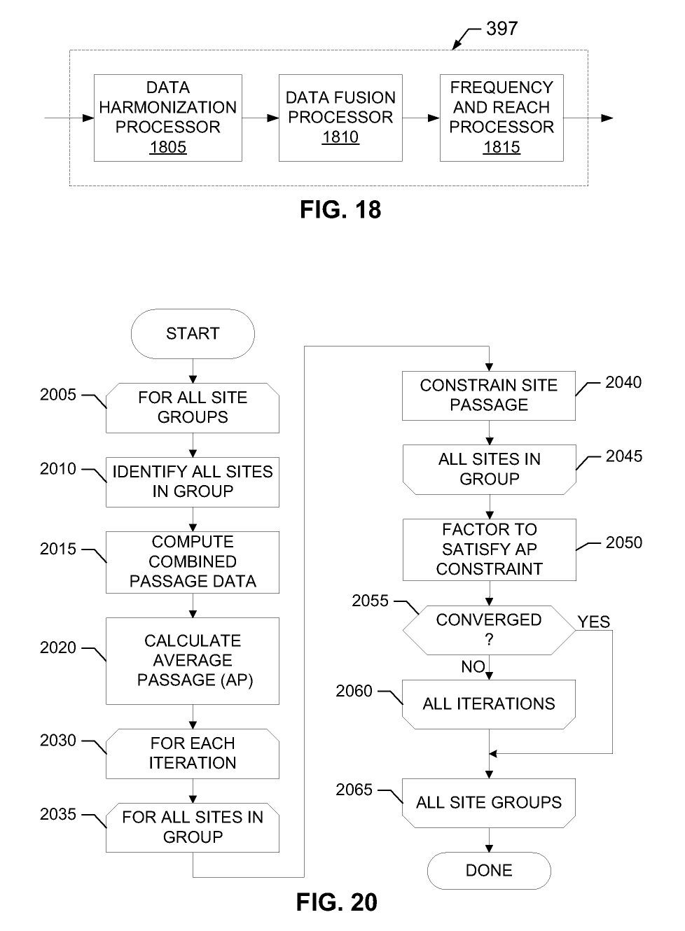

FIG. 19 illustrates example passage data before, during and after harmonization by the example harmonization processor 1805. The example of FIG. 19 illustrates passage data for three sites in a media site group (e.g., same media site owner, same media site type, etc.). The 2^{nd} column shows TAB DEC passage data for these sites, and the 3^{rd} column shows the passage data determined, e.g., by the example passage processor 328 of FIG. 3, and the example device 200. The 4^{th} column shows the passage data after constraining the data to within +/−20% of the TAB DEC passage data. The 5^{th} column shows the passage data after being factored to meet the constraint that the average passage be maintained. The 6^{th} and 7^{th} columns show the resulting passage data after the 2^{nd} iteration. Finally, the last column shows fully converged harmonized passage data that is closer in character to the TAB DEC passage data while maintaining the original overall average passage.

Returning to FIG. 18, to impute missing demographic data or information (e.g., a respondent may not have indicated race, language, employment status, occupation, income, etc.), the statistics processing device 397 includes a data fusion processor 1810. Using any of a variety of well-known data fusion techniques, the data fusion processor 1810 imputes or otherwise determines missing demographic data. The example data fusion processor 1810 of FIG. 18 assumes that the gender demographic is complete, accurate and available for each respondent, and it will be used as linking variables or “hooks” for the purposes of data fusion. Other linking variables may be age, county of residence, etc., and are assumed to also be available for each respondent.

Data fusion techniques operate on the principle that a respondent's missing data can be imputed from respondents with similar characteristics. For example, two respondents sharing common age, gender, location and occupation are statistically more likely to have a similar income than a random matching of respondents would provide. Thus, by locating respondents with similar characteristics and sharing common linking variables, missing demographics such as income of the first respondent can be reliably (from a statistics perspective) imputed from the income of the second respondent.

In an example, the respondents are split into two groups within each gender: recipients who have at least one missing demographic, and donors who have complete demographic records. Thus, four groups are created: #1(male, donors), #2(male, recipients), #3(female, donors), and #4(female, recipients). Next, within each gender, a statistical difference is computed between each recipient and each donor. Finally, each recipient is matched with the donor having the smallest statistical difference, and demographic information from the donor is used for the recipient. It will be readily apparent to persons of ordinary skill in the art that any suitable statistical difference can be employed. In the example, the statistic difference is computed as a well-known modified Mahalanobis distance. This modified Mahalanobis distance is the distance between two N dimension points scaled by the statistical variation, correlation and importance of each component of the point. In the example of FIG. 18, the two N dimension points represent the income, by media site, for the recipient and the donor, where N is the number of media sites.

To generate a model suitable for characterizing the effectiveness (i.e., reach and frequency) of exposure or consumption of a media site (or media site type, owner, etc.), the statistics processing device 397 includes a frequency and reach processor 1815. In an example, the frequency and reach processor 1815 determines the parameters of a well-known Gamma Poisson distribution (i.e., a negative binomial distribution (NBD)). In the example, the frequency and reach processor 1815 calculates 9-day Gross Rating Points (GRPs) for a schedule (i.e., set of media sites selected based on one or more criteria) based on the passage data. The frequency and reach processor 1815 then uses one of a variety of well-known techniques to estimate from the GRPs and reach the model parameters. Next, the frequency and reach processor 1815 uses the estimated model parameters to rate media effectiveness over a pre-determined time duration (i.e., reach and frequency values). It will be readily apparent to persons of ordinary skill in the art that other suitable models could be used; and that other suitable methods useful for determining model parameters, and reach and frequency values from the passage data could be used.

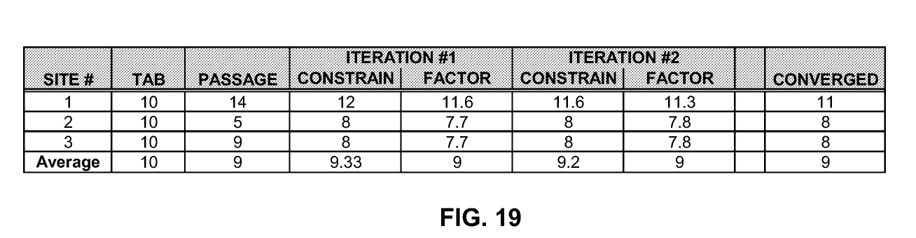

FIGS. 20, 21, and 22 illustrate a flowchart representative of example machine readable instructions that may be executed by a processor (e.g., one of the processors 2305A-C of FIG. 23) to implement the data harmonization processor 1805, the data fusion processor 1810, and the frequency and reach processor 1815, respectively. The machine readable instructions of FIGS. 20-22, the data harmonization processor 1805, the data fusion processor 1810, and/or the frequency and reach processor 1815 may be executed by a processor, a controller and/or any other suitable processing device. For example, the machine readable instructions of FIGS. 20-22, the data harmonization processor 1805, the data fusion processor 1810, and/or the frequency and reach processor 1815 may be embodied in coded instructions stored on a tangible medium such as a flash memory, or random access memory (RAM) associated with the processors 2305A-C shown in the example processor platform 2300 and discussed below in conjunction with FIG. 23. Alternatively, some or all of the example machine readable instructions of FIGS. 20-22, the data harmonization processor 1805, the data fusion processor 1810, and/or the frequency and reach processor 1815 may be implemented using an application specific integrated circuit (ASIC), a programmable logic device (PLD), a field programmable logic device (FPLD), discrete logic, hardware, software, and/or firmware. Also, some or all of the example machine readable instructions of FIGS. 20-22, the data harmonization processor 1805, the data fusion processor 1810, and/or the frequency and reach processor 1815 may be implemented manually or as combinations of any of the foregoing techniques. Further, although the example machine readable instructions of FIGS. 20-22 are described with reference to the flowchart of FIGS. 20-22, persons of ordinary skill in the art will readily appreciate that many other methods of implementing the data harmonization processor 1805, the data fusion processor 1810, and/or the frequency and reach processor 1815, all of FIG. 18, may be employed. For example, the order of execution of the blocks may be changed, and/or some of the blocks described may be changed, eliminated, or combined.

The example machine readable instructions of FIG. 20 begin with the data harmonization processor 1805 processing each media site group (e.g., media site owner, media site type, etc.) (block 2005). For a media site group, the data harmonization processor 1805 identifies all media sites belonging to the media site group (block 2010). The data harmonization processor 1805 then combines passage data by adding together the passage data for all respondents for each media site (block 2015). Then, the data harmonization processor 1805 computes the average of the passage data (ΔP) for the identified media sites (block 2020). For each iteration of data harmonization (block 2030), the data harmonization processor 1805 processes each media site in the media group (block 2035). For each media site (block 2035), the data harmonization processor 1805 constrains the passage data for the site to within +/−20% of the TAB DEC passage data (block 2040). If not all media sites in the media site group have been processed (block 2045), the data harmonization processor 1805 returns to block 2035 to process the next media site in the media site group. Otherwise, if all media sites in the media site group have been processed (block 2045), the data harmonization processor 1805 factors (as described above) the passage data for the media sites in the media site group (block 2050).

Next, the data harmonization processor 1805 determines (as described above) if data harmonization of the passage data has converged (block 2055). If convergence has occurred (block 2055), the data harmonization processor 1805 proceeds to block 2065 to determine if all media site groups have been processed. Otherwise, if convergence has not occurred (block 2055), the data harmonization processor 1805 returns to block 2030 to process the next iteration.

If all media site groups have been processed (block 2065), the data harmonization processor 1805 ends execution of the example machine readable instructions of FIG. 20. Otherwise, if not all media site groups have been processed (block 2065), the data harmonization processor 1805 returns to block 2005 to process the next media site group.

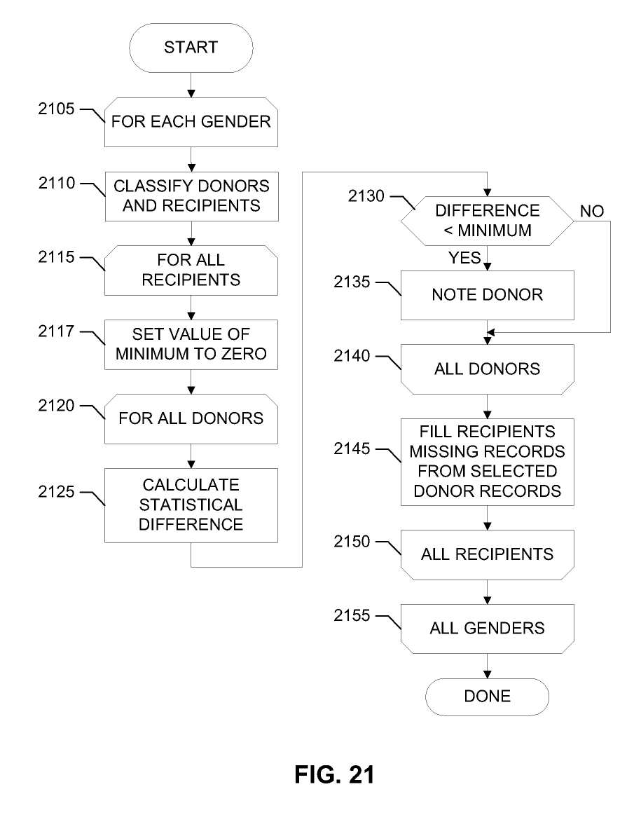

The example machine readable instructions of FIG. 21 begin with the data fusion processor 1810 processing each gender (block 2105). Within each gender (block 2105), the data fusion processor 1810 classifies each respondent 102 as a donor or recipient based on whether or not they have complete demographic information (block 2110). For each of the identified recipients (block 2115), the data fusion processor 1810 sets the current minimum to a value of zero (block 2117), and processes all donors of the same gender (block 2120). For a donor (block 2120), the data fusion processor 1810 computes the statistical difference (as discussed above) between the recipient and the donor (block 2125). If the statistical difference is less than the current minimum (block 2130), the data fusion processor 1810 notes the donor (i.e., records information identifying the donor) and updates the minimum value equal to the statistical difference (block 2135).

If the data fusion processor 1810 has not computed the statistical difference for all donors of the same sex (block 2140), the data fusion processor 1810 returns to block 2120 to process the next donor. If all donors have been processed (block 2140), the data fusion processor 1810 fills in missing demographic information for the recipient from the noted donor (block 2145). If the data fusion processor 1810 has not processed all recipients (block 2150), the data fusion processor 1810 returns to block 2115 to process the next recipient. If all recipients have been processed (block 2150), and not all genders have been processed (block 2155), the data fusion processor 1810 returns to block 2105 to process the next gender. If all genders have been processed (block 2155), the data fusion processor 1810 ends execution of the example machine readable instructions of FIG. 21.

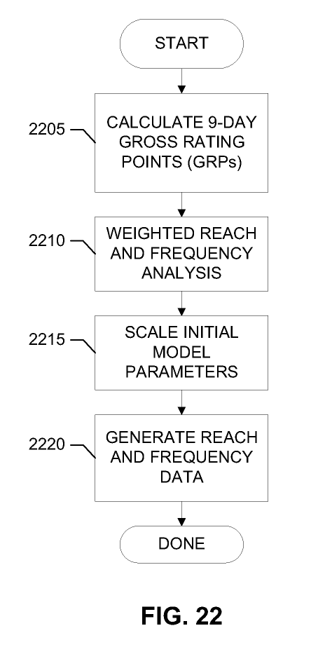

The example machine readable instructions of FIG. 22 begin with the reach and frequency processor 1815 calculating 9-day GRP's for a pre-determined set of nine days using the harmonized passage data for a pre-determined set of media sites (i.e., schedule) (block 2205). The reach and frequency processor 1815 then performs a weighted reach and frequency analysis using the passage data for respondents reporting on day 1 of the pre-determined set of nine days (block 2210). The output of the analysis is used to generate initial parameters for the Gamma Poisson model. Next, the reach and frequency processor 1815 scales the initial model parameters to ensure that the model produces results that are consistent with the harmonized 9-day GRP's (block 2215), and the scaled parameters are used to calculate the desired reach and frequency data (block 2220).

FIG. 23 illustrates the example processor system 2300 capable of implementing the methods and apparatus disclosed herein. The processor system 2300 includes one or more processors 2305A-C having associated system memory. The system memory may include one or more of a random access memory (RAM) 2315 and a read only memory (ROM) 2317.

The plurality of processors 2305A-C, in the example of FIG. 23, are coupled to an input/output controller hub (ICH) 2325 to which other peripherals or devices are interfaced. In the illustrated example, the peripherals interfaced to the ICH 2325 include an input device 2327, a mass storage device 2340 (e.g., hard disk drive), a universal serial bus (USB) 2345, a USB device 2350, a network port 2355, which is further coupled to a network 2360, and/or a removable storage device drive 2357. The removable storage device drive 2357 may include associated removable storage media 2358, such as magnetic or optical media. One or more peripherals may implement the providing of recorded position fix data 305 by the download server 120. The mass storage device 2340 may be used to store the example machine readable instructions illustrated in FIGS. 6A-C, 15-17, and 20-22.

The example processor system 2300 of FIG. 23 also includes a video graphics adapter card 2320, which is a peripheral coupled to a memory controller hub (MCH) 2310 and further coupled to a display device 2322.

The example processor system 2300 may be, for example, a conventional desktop personal computer, a notebook computer, a workstation, a network server, or any other computing device. The processors 2305A-C may be any type of processing unit, such as a microprocessor from the Intel® Pentium® family of microprocessors, the Intel® Itanium® family of microprocessors, the Intel XScale® family of processors, the AMD® Athlon™ family of processors, and/or the AMD® Opteron™ family or processors. The processors 2305A-C may execute the example machine readable instructions of FIGS. 6A-C, 15-17, and 20-22 to implement the MECD 300, the pre-processor 308, the travel path processor 310, the media site processor 320, the passage processor 328, the statistics processing device 397, the data harmonization processor 1805, the data fusion processor 1810, and/or the frequency and reach processor 1815.

The memories 2315 and 2317, which form some or all of the system memory, may be any suitable memory or memory devices and may be sized to fit the storage demands of the system 2300. Additionally, the mass storage device 2340 may be, for example, any magnetic or optical media that is readable by the processors 2305A-C. The system memory may be used to store the recorded travel path data 305, the enhanced travel path data 315, the media site location data 325, and/or the database 130. The system memory may also be used to store the example machine readable instructions illustrated in FIGS. 6A-C, 15-17, and 20-22.

The input device 2327 may be implemented by a keyboard, a mouse, a touch screen, a track pad or any other device that enables a user to provide information to the processors 2305A-C.

The display device 2322 may be, for example, a liquid crystal display (LCD) monitor, a cathode ray tube (CRT) monitor, or any other suitable device that acts as an interface between the processors 2305A-C and a user via the video graphics adapter 2320. The video graphics adapter 2320 is any device used to interface the display device 2322 to the MCH 2310. Such cards are presently commercially available from, for example, Creative Labs and other like vendors.

The removable storage device drive 2357 may be, for example, an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 2358 is complementary to the removable storage device drive 2357, inasmuch as the media 2358 is selected to operate with the drive 2357. For example, if the removable storage device drive 2357 is an optical drive, the removable storage media 2358 may be a CD-R disk, a CD-RW disk, a DVD disk or any other suitable optical disk. On the other hand, if the removable storage device drive 2357 is a magnetic media device, the removable storage media 2358 may be, for example, a diskette, or any other suitable magnetic storage media. The removable storage media 2358 may also be used for providing the recorded position fix by the download server 120 or for storing the database 130.

The example processor system 2300 also includes the network port 2355 (e.g., a processor peripheral), such as, for example, an Ethernet card or any other card that may be wired or wireless. The network port 2355 provides network connectivity between the processors 2305A-C and the network 2360, which may be a local area network (LAN), a wide area network (WAN), the Internet, or any other suitable network. The network port 2355 and the network 2360 may also be used for providing the recorded position fix by the download server 120

Of course, persons of ordinary skill in the art will recognize that the order, size, and proportions of the memory illustrated in the example systems may vary. Additionally, although this patent discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods, machine readable instructions, and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular standards and protocols, it sis understood that the teachings of the disclosure are not limited to such standards and protocols. For instance, each of the standards for Internet and other packet switched network transmission (e.g., Transmission Control Protocol (TCP)/IP, User Datagram Protocol (UDP)/IP, HyperText Markup Language (HTML), HyperText Transfer Protocol (HTTP)); and inter-computer and inter-device communications (e.g., USB) represent examples of the current state of the art. Such standards are periodically superseded by faster or more efficient equivalents having the same general functionality. Accordingly, replacement standards and protocols having the same functions are equivalents which are contemplated by the teachings of the disclosure are intended to be included within the scope of the accompanying claims.

The teachings of the disclosure contemplate one or more machine readable mediums containing instructions, or receiving and executing instructions from a propagated signal so that, for example, a device connected to a network environment can send or receive voice, video or data, and communicate over the network using the instructions. Such a device can be implemented by any electronic device that provides voice, video or data communication, such as a telephone, a cordless telephone, a mobile phone, a cellular telephone, a Personal Digital Assistant (PDA), a set-top box, a computer, and/or a server.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method of crediting media exposure comprising:
deriving a plurality of travel paths traversed by respective ones of a plurality of respondents;
determining, via a first technique, exposures of the respective ones of the plurality of respondents to a plurality of media sites based on the derived plurality of travel paths; and
modifying the determined exposures to the plurality of media sites to improve a statistical accuracy of the modified determined exposures by constraining the determined exposures based on exposure information for the plurality of media sites obtained via a second technique different than the first technique.

2. A method defined in claim 1, further comprising
modifying the determined exposures after constraining the determined exposures based on an average value associated with the determined exposures prior to constraining the determined exposures.

3. A method as defined in claim 1, wherein deriving the plurality of travel paths traversed by the respective ones of the plurality of respondents comprises:
processing data representative of locations of a respondent recorded by an electronic device to enhance at least one of a completeness or an accuracy of the recorded data;
deriving a sequence of position fixes from the processed data; and
modifying the derived position fixes to align with a known course of travel.

4. A method as defined in claim 1, wherein determining the exposures of the respective ones of the plurality of respondents to the plurality of media sites based on the derived plurality of travel paths comprises:
determining an impact zone and favorable directions of travel associated with a media site; and
crediting media exposure to the media site if a respondent traverses within the impact zone in at least one of the favorable directions.

5. A method as defined in claim 1, wherein modifying the determined exposures to the plurality of media sites to improve the statistical accuracy of the modified determined exposures comprises iteratively modifying media site exposure data to satisfy at least one constraint associated with a difference between a statistical value of the exposure information obtained via the second technique and a statistical value associated with the modified determined exposures.

6. An apparatus, comprising a processor coupled to a memory and programmed to:
derive a plurality of travel paths traversed by respective ones of a plurality of respondents;
determine, via a first technique, exposures of the respective ones of the plurality of respondents to a plurality of media sites based on the derived plurality of travel paths; and
modify the determined exposures to the plurality of media sites to improve a statistical accuracy of the modified determined exposures by constraining the determined exposures based on exposure information for the plurality of media sites obtained via a second technique different than the first technique.

7. An apparatus as defined in claim 6, wherein the processor is programmed to:
modify the determined exposures after constraining the determined exposures based on an average value associated with the determined exposures prior to constraining the determined exposures.

8. An apparatus as defined in claim 6, wherein the processor is programmed to derive the plurality of travel paths traversed by the respective ones of the plurality of respondents by:
processing data representative of locations of a respondent recorded by an electronic device to enhance at least one of a completeness or an accuracy of the recorded data;
deriving a sequence of position fixes from the processed data; and
modifying the derived position fixes to align with a known course of travel.

9. An apparatus as defined in claim 6, wherein the processor is programmed to determine the exposures of the respective ones of the plurality of respondents to the plurality of media sites based on the derived plurality of travel paths by:
determining an impact zone and favorable directions of travel associated with a media site; and
crediting media exposure to the media site if a respondent traverses within the impact zone in at least one of the favorable directions.

10. An apparatus as defined in claim 6, wherein the processor is programmed to modify the determined exposures to the plurality of media sites to improve the statistical accuracy of the modified determined exposures by iteratively modifying media site exposure data to satisfy at least one constraint associated with a difference between a statistical value of the exposure information obtained via the second technique and a statistical value associated with the modified determined exposures.

11. A machine readable medium having instructions stored thereon that, when executed, cause a machine to:
derive a plurality of travel paths traversed by respective ones of a plurality of respondents;
determine, via a first technique, exposures of the respective ones of the plurality of respondents to a plurality of media sites based on the derived plurality of travel paths; and
modify the determined exposures to the plurality of media sites to improve a statistical accuracy of the modified determined exposures by constraining the determined exposures based on exposure information for the plurality of media sites obtained via a second technique different than the first technique.

12. (canceled)

13. (canceled)

14. (canceled)

15. (canceled)

16. A method for modifying the statistical accuracy of media site exposure data comprising:
obtaining the media site exposure data via a first technique; and
modifying the media site exposure data by constraining the media site exposure data based on exposure information obtained via a second technique different than the first technique.

17. A method as defined in claim 16, further comprising modifying the media site exposure data after constraining the media site exposure data based on an average value associated with the media site exposure data prior to constraining the media site exposure data.

18. A method as defined in claim 16, further comprising repeating the modification of the media site exposure data to satisfy a constraint associated with a difference between a statistical value of the exposure information obtained via the second technique and a statistical value associated with the modified media site exposure data.

19. A method as defined in claim 17, further comprising ending the repeating modifications of the media site exposure data if a maximum number of iterations have occurred.

20. A method as defined in claim 17, further comprising ending the repeating modifications of the media site exposure data if a pre-determined convergence criterion is satisfied.

21. A method as defined in claim 16, wherein constraining the media site exposure data comprises limiting the media site exposure data to be within a pre-determined range.

22. A method as defined in claim 16, wherein the exposure information associated with the second technique comprises Traffic Audit Bureau traffic survey data.

23. A method as defined in claim 17, wherein the statistical values comprise average values.

24. A method as defined in claim 16, further comprising modifying the media site exposure data to impute missing demographic data.

25. A method as defined in claim 24, wherein data fusion is used to impute the missing demographic data.

26. A method as defined in claim 16, further comprising generating a frequency and reach from the modified media site exposure data.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)
